(19) United States
(12) Patent Application Publication
(10) Pub. No.: US 2020/0321630 A1
(43) Pub. Date: Oct. 8, 2020

(54) DROPLET-IMPINGEMENT, FLOW-ASSISTED ELECTRO-FENTON PURIFICATION USING HETEROGENEOUS SILICA/IRON NANOCOMPOSITE CATALYST

(71) Applicant: King Fahd University of Petroleum and Minerals, Dhahran (SA)

(72) Inventors: Chanbasha BASHEER, Dhahran (SA); Muhammad Baseer HAIDER, Dhahran (SA); Hakimu NSUBUGA, Dhahran (SA)

(73) Assignee: King Fahd University of Petroleum and Minerals, Dhahran (SA)

(21) Appl. No.: 16/376,460

(22) Filed: Apr. 5, 2019

(51) Int. Cl. H01M 4/96; H01M 4/88; H01M 4/90; C02F 1/467

(52) U.S. Cl. CPC H01M 4/96; H01M 4/8892; H01M 4/9075; C02F 2101/30; C02F 1/4672; C02F 2305/026; H01M 4/8803

(57) ABSTRACT

A droplet-impingement, flow-assisted electro-Fenton (DFEF) catalyst, system, and method can degrade to trace level organic materials, such as β-blockers in water. A silica/carbon-x % iron composite (RHS/C-x % Fe) can be made, e.g., from rice husks and iron ions into heterogeneous catalysts of varied iron content. The DFEF approach can improve oxygen saturation, mass transfer of β-blockers at the cathode, and continuous electrogeneration of hydroxyl radicals (.OH) in solution and at boron-doped anode surfaces. A central composite design (CCD) can reduce costs and increase efficiency. Beta-blockers can be completely degraded within 15 minutes, following pseudo first-order kinetics with rate constants of 0.19 to 2.72×10⁻² (acebutolol) and 0.16 to 2.54×10⁻² (propranolol) at increasing catalyst concentration. Beta-blocker degradation can be mostly by .OH_{bulk} rather than .OH_{adsorbed} for anodic oxidation (AO) at BDD electrode. The degradation efficiency of β-blockers can be: DFEF>FEF>BEF>AO.

### STATEMENT OF ACKNOWLEDGEMENT

The inventors gratefully acknowledge the funding support of the Deanship of Scientific Research at King Fahd University of Petroleum and Minerals through a project grant No. 151024.

### STATEMENT REGARDING PRIOR DISCLOSURES BY INVENTOR(S)

Aspects of the present disclosure are described in “Droplet flow-assisted heterogeneous electro-Fenton reactor for degradation of beta-blockers: response surface optimization, and mechanism elucidation,” which was authored by the inventors and published online in Environ. Sci. Pollut. Res. 2019, pp. 1-15, on Mar. 12, 2019, which is incorporated herein by reference in its entirety.

### BACKGROUND OF THE INVENTION

### Field of the Invention

The present disclosure relates to the treatment and/or purification of aqueous compositions, such as various waste waters, and the degradation of organic compounds contaminating water using a heterogeneous Fenton catalyst, optionally based on rice husk-based silica, containing iron, as well as to electrochemical cells and droplet impingement, flow-assisted Fenton processes for purifying organic-contaminated water.

### Description of the Related Art

Beta blockers (β-blockers) are a class of drugs used widely in hospitals and homes to manage myocardial infarctions. As a result of their use, excretion, and disposal, substantial amounts of β-blockers and their metabolites have been repeatedly measured in wastewater treatment plants, hospital wastewater (HWW) effluent, and even drinking water. Beta-blockers are resistant to removal by conventional physicochemical and biological wastewater treatment technologies. Studies have indicated that the cumulative ecotoxicological effects of β-blockers in both aquatic organisms and plants can accrue even at concentrations of ng/L to μg/L. The lack of efficient water treatment technologies to degrade β-blockers, alongside inadequate analytical techniques, has limited deeper understanding of β-blocker degradation and transformation pathways. Most degradation studies of emerging contaminants in water environments have mainly focused on the disappearance of parent compounds as a proof of degradation, often neglecting intermediates which might even be more toxic.

A combination of electrochemical degradation methods with liquid chromatography tandem mass spectrometry (LC-MS/MS) analysis may present a more appealing approach towards prediction and evaluation of trace level multi-analyte degradation pathways and intermediate products identification. In recent years, electrochemical advanced oxidation processes (EAOP) have been reported as environmentally friendly, low cost, highly efficient methods for effective and non-selective removal of recalcitrant organic pollutants including beta blockers in environmental water matrices. Among EAOPs, the heterogeneous electro-Fenton (EF) process represents an attractive and highly effective treatment method with enhanced capability to mineralize refractory organic pollutants in wastewater. Fenton reactions have a mode of action involving continuous in-situ production of hydrogen peroxide at the cathode, by reduction of supplied oxygen/air, as seen in Table 1, Equations 1 to 3, and subsequent generation of .OH radicals when iron ion catalysts, Fe³⁺/Fe²⁺, seen in Equation 3, or iron oxides are externally added. The active .OH radical is one of the strongest oxidants known, E°_{(.OH/H2O)}=2.80 V, and therefore can oxidize nearly all pollutants to non-toxic compounds, e.g., CO₂ and H₂O, or less toxic compounds.

TABLE 1
Major reactions of the Fenton process, wherein ‘PH’ is organic pollutant.

| | | | |
|---|---|---|---|
| O_{2(gas)} + 2H⁺ + 2 e⁻→ H₂O₂ | Eq. 1 | Fe³⁺ + HO₂^{•} → Fe²⁺ + O₂ + H⁺ | Eq. 5 |
| Fe³⁺ + e⁻ → Fe²⁺ | Eq. 2 | Fe²⁺ + HO₂^{•} → Fe³⁺ + HO₂⁻ | Eq. 6 |
| Fe²⁺ + H₂O₂ → Fe³⁺ + OH⁻ + ^{•}OH | Eq. 3 | Fe²⁺ + ^{•}OH → Fe³⁺ + ⁻OH | Eq. 7 |
| ^{•}OH + H₂O₂ →H₂O + HO₂^{•} | Eq. 4 | ^{•}OH + PH → P^{•} + H₂O | Eq. 8 |

An advantage of the Fenton process is that no toxic chemical reagents are added and no hazardous waste is generated during the treatment process. In addition, the Fenton process continuously regenerates Fe²⁺, as seen in Table 1, Equations 4 and 5, so only a relatively small amount of Fe²⁺/Fe³⁺ is necessary to catalytically enhance the degradation process.

The increased degradation capability of the Fenton process can depend substantially on the reactor design, cathode materials, and the type of catalyst. To circumvent limitations associated with batch reactors, such as limited mass transfer and inadequate treatment, continuous flow reactors have successfully been proposed, including vertical flow, baffled, tubular, continuous stirred tank, and plunger flow reactors. These flow systems can enhance convective transfer of pollutant particles to exposed electrode surfaces. The Fenton reaction relies on the continuous generation of H₂O₂ at a cathode, and carbon-based cathode materials, such as carbon felt, graphite, carbon nanotubes, gas diffusion electrodes, reticulated vitreous carbon, activated carbon fiber and boron-doped diamond (BDD) have been reported to have good performance. When BDD is employed as an anode in an electro-Fenton process, highly reactive heterogeneous hydroxyl radicals, BDD (.OH), can be formed at the anode surface, Equation 9, which may augment the effectiveness of the EF process.

BDD+H₂O→B(.OH)+H⁺+e⁻ Eq. 9

BDD electrodes exhibit wide electrochemical potential, high oxygen evolution potential windows and good physical and chemical stability, and can be useful anodes for electrochemical oxidation in certain applications.

Using heterogeneous catalysts as an iron source in the Fenton reaction may reduce operational costs related to addition and recovery of iron ions, regulation of pH to acidic conditions (2.8 to 3), avoidance of sludge formation, e.g., from the precipitation of iron ions, and high costs in controlling degradation kinetics typical of a classical EF process. Easy, cheap, effective, and environmentally appealing heterogeneous iron-modified Fenton catalysts have been the subject of research. It is postulated that adding an iron-carbon composite material to an electrolytic solution may form a multitude of micro-galvanic cells in which iron serves as anode and carbon as cathode, leading to in situ leaching of numerous Fe²⁺ ions. This leaching could facilitate the degradation of pollutant via electrogenerated .OH radicals.

Hydrolytic sol-gel iron modified rice husk silica composite materials may provide suitable alternatives for enhanced catalytic oxidation of organic pollutants in contaminated environmental waters. The use of rice husk silica as a matrix/substrate for loading iron may offer several advantages, such as abundancy, ease of processing and low cost. The sol-gel technique can homogeneously trap added metal ion within the polymerized gel which ultimately, after calcination, can result in M-O-M bonds in the silica matrix. Fenton systems using heterogeneous iron sources may allow pollutant degradation efficiency even under neutral pH conditions. However, the utility of electro-Fenton is limited by high electrical energy demand and correspondingly higher operational costs. Hence, the optimization of operational parameters, such as current density, operational pH, reaction time, and Fe³⁺/Fe²⁺ concentration may offer useful solutions for water treatment.

Traditional electro-Fenton univariate optimization probes one factor at a time while leaving the remaining operational factors fixed. Univariate optimization poorly accounts for interactive effects of the main parameters and is expensive and time consuming for multi-parameter analysis. Multivariate optimization techniques have been introduced to merge process optimization of main variables with interaction effects, maximizing the response output. Of available response surface methodologies, central composite design (CCD) is the most flexible and efficient design capable of generating sufficient experimental data using minimal experimental runs. CCD can be useful to explain the curvilinear parameters and pairwise interaction effects of experimental data. Hence, using multivariate experimental designs in developing and studying wastewater treatment could improve process optimization for electro-Fenton systems. Various attempts are known from the art.

CN 106540696 A by Qu et al. (Qu) discloses a preparation method for rice husk based metal-catalyst-loaded mesoporous silica, exploring optimal preparation conditions and degradation properties of the iron-loaded mesoporous silica in dyestuff waste water. Qu uses rice husks as a silicon source and ferric nitrate as an iron source, and the synergistic effect of lignin in the rice husks and polyethylene glycol (PEG) to prepare the iron-loaded mesoporous silica. Qu's catalyst-loaded mesoporous silica has good dispersity, a uniform size, a larger specific surface area and a larger pore volume, but Qu requires PEG instead of cetyl trimethyl ammonium bromide (CTAB) and glycerol as structure directing agents. Qu discusses neither electrochemical cell details, nor droplet-impingement, flow-assisted electro-Fenton (DFEF) reactions.

CN 106111071 A by Chen et al. (Chen) describes a similar system to Qu, forming silica from rice husk ash to precipitate magnetic ferrite, however, Chen produces sulfydryl modified magnetic mesoporous SiO₂ for reducing heavy metals, such as cadmium, in waste water. Chen does not remediate contaminated water by degradation of organic pollutants in wastewater, nor does Chen describe a droplet-impingement, flow-assisted electro-Fenton (DFEF) system.

CN 105688961 A by Shi et al. (Shi) discloses an iron-based catalyst supported on silica, using silica from rice husk ash. Shi precipitates aq. Fe(NO₃)₃.9H₂O in rice husks with NH₄OH, NaOH, and/or Na₂CO₃ at 50 to 80° C. and a pH of from 7 to 9 before calcining, to produce an iron carbide and rice hull ash (Fe—C/RHA) catalyst. Shi's catalyst has Fe in 1 to 60 wt. % of the total catalyst mass. However, Shi is silent on its catalyst's physical properties, such as pore size and surface area. Shi does not mention using the catalyst in an electrochemical cell. While Shi discusses nitrate-laden wastewater from synthesizing catalysts, does not discuss degradation/remediation of organic pollutants in contaminated water using a heterogeneous electro-Fenton catalyst, let alone droplet-impingement, flow-assisted electro-Fenton.

CN 100453472 C by Wang et al. (Wang) and CN 102092820 A by Zhang et al. (Zhang) describe Fenton processes of degrading contaminants in wastewater. However, both processes require light irradiation, e.g., from a ultraviolet mercury lamp or photovoltaic film /visible light, as well as a pH of 3, generally described as pH 2 to 7, in a batch reactor. Wang and Zhang do not describe heterogeneous droplet-impingement, flow-assisted electro-Fenton (DFEF) systems.

CN 107848845 A by Lefebvre et al. (Lefebvre) discloses an electro-Fenton apparatus requiring a non-graphene carbon cathode that is coated with graphene, the cathode optionally being paired with any suitable anode, such as a boron-doped diamond anode. Lefebvre's electrochemical cell may treat waste water, but does not use a composite catalyst as a source of iron, nor particularly droplet-impingement, flow-assisted electro-Fenton (DFEF) systems.

CN 106582774 A by Zheng et al. (Zheng) discloses an iron-copper bi-metal loading meso-porous silicon heterogeneous Fenton catalytic material. Zheng's method comprises: mixing Mg powder with an SBA-15 material, heating at 500- to 550° C., cooling, acid washing, water washing, and drying to obtain a meso-porous silicon material. Fe salt, Cu salt, and meso-porous silicon are weighed, dissolved into ethanol, stirring and drying at 40 to 80° C., calcining for 2-3 hours under Ar at 200 to 250° C., to obtain a heterogeneous catalyst for Fenton degradation of dye wastewater. However, Zheng requires Cu and Mg-doped SBA-15, and does not detail the use of its catalyst within an electrochemical cell. Zheng does not describe droplet-impingement, flow-assisted electro-Fenton (DFEF) reactions.

U.S. Pat. No. 9,075,037 to the present inventors (Basheer) discloses a method of making a silica-supported iron composite catalyst from rice husk. Basheer uses a microextraction sample preparation technique to increase HPLC sensitivity for trace analysis. Basheer's material is not used for degrading organic contaminants in water, nor an electrochemical cell, but instead, to abstract haloacetic acids using a microsolid phase extraction technique.

Environ. Chem. Lett. 2018, 16(1), 281-286 by Gazenko et al. (Ganzenko) describes breaking down cytostatic drug pollutants in water, particularly removing 5-fluorouracil from water using the electro-Fenton process. Galvanostatic electrolyses were performed with an undivided laboratory-scale cell equipped with a boron-doped diamond anode and a carbon felt cathode. Gazenko reports the fastest degradation at 0.2 mM Fe²⁺ catalyst concentration, a 5-fluorouracil oxidation rate constant of 1.52×10⁹/(M·s). After 6 hours the solution mainly contained NH₄⁺, NO₃⁻, and F⁻, and less than 10% of residual organic carbon. Ganzenko states that electro-Fenton may be used to degrade biorefractory drugs. Rather than using a composite catalyst, Gazenko uses iron(II) sulfate heptahydrate as a source of iron. Gazenko's process also operates at a pH of 3.0, and is operated in batch mode.

Water Res. 2010, 44(10), 3109-3120 by Sires et al. (Sires) discloses electrochemical decontamination of β-blocker polluted water by anodic oxidation (AO) and electro-Fenton (EF), at lab-scale via bulk electrolysis at pH 3.0 at constant current using a carbon-felt cathode. Sires showed AO to be more effective with a boron-doped diamond (BDD) than a Pt anode, and EF with a Pt anode and 0.2 mmol/L Fe² performed better, with pseudo-first order kinetics. Multicomponent solution kinetics showed: atenolol (1.42×10⁹ L/mol·s)<metoprolol (2.07×10⁹ L/mol·s)<propranolol (3.36×10⁹ L/mol·s). Sires does not mention of using a composite catalyst as a source of iron, instead using a homogeneous electro-Fenton process in a batch reaction. Sires does not disclose heterogeneous flow-based, droplet-assisted electro-Fenton reactor, nor rice husk-based silica/carbon-iron catalysts.

Chem. Eng. J. 2013, 229, 351-363 by Gan et al. (Gan) discloses a rice hull-based silica supported iron catalyst—aggregated silica nanospheres with about 3 wt. % of iron—in heterogeneous Fenton-like degradation of Rhodamine B achieved almost completely within 10 minutes at an initial pH of 3.0. Gan reports that salts found in textile wastewater such as Na₂SO₄ and NaCl enhance the degradation rate of Gan's catalyst. Gan does not describe the catalyst as mesoporous silica, nor flow-based, droplet-assisted electro-Fenton reaction.

In light of the above, a need remains for improvements in catalysts and catalytic organic contaminant decomposition, particularly in water, and particularly using flow-based systems, as well as methods of making such catalysts.

### SUMMARY OF THE INVENTION

Aspects of the invention provide heterogeneous catalysts, comprising: Fe³⁺ ions in a range of from 8 to 12 wt. %, based on total catalyst weight; and a support comprising at least 75 wt. %, based on total support weight, of a mesoporous amorphous silica, the support being impregnated with the Fe³⁺ ions, wherein the catalyst has a BET surface area in a range of from 50 to 80 m²/g, wherein the catalyst has an average pore diameter in a range of from 4 to 10 nm, and wherein the mesoporous amorphous silica is produced by a process comprising calcining a mixture comprising a silicate and a structure directing agent comprising glycerol and a C10 to C20-alkyl trialkylammonium halide. Such catalysts may be modified by any permutation of the features described herein, particularly the following.

Aspects of the invention include electrochemical cells, comprising: a carbon-based cathode; an anode; a heterogeneous catalyst; an electrolyte solution in contact with the cathode, the anode, and the catalyst; and a source of gaseous oxygen configured to produce oxygen-containing bubbles in the electrolyte solution near the carbon-based cathode, wherein the catalyst comprises: Fe³⁺ ions in a range of from 5 to 20 wt. %, based on total catalyst weight; and a support comprising at least 75 wt. %, based on total support weight, of a mesoporous amorphous silica, the support being impregnated with the Fe³⁺ ions.

Useful catalysts may have a BET surface area in a range of from 25 to 100 m²/g and/or an average pore diameter in a range of from 2 to 20 nm. The catalyst(s) may be present in the electrolyte solution in a range of from 50 to 200 pg/mL electrolyte solution.

Useful mesoporous amorphous silicas for the support may be made by a process comprising: contacting a silicate with a structure directing agent comprising glycerol, to obtain a mixture comprising the silicate and the glycerol; and calcining the mixture for at least 1 hour at a temperature in a range of from 500 to 1000° C. Useful structure directing agents may further comprise a fatty acid ammonium halide.

Anodes useful in the invention may be silicon/boron-doped diamond anodes and/or useful cathode may be polymer-based graphite felt electrodes.

Aspects of the invention provide methods, comprising: passing water comprising an organic compound through one or more electrochemical cells in any inventive permutation described herein, thereby subjecting the organic compound to a droplet-impingement, flow-assisted Fenton reaction to degrade the organic compound, wherein the passing reduces a content of the organic compound in the water by at least 90 wt. % from an inlet of the cell to an outlet of the cell within 20 minutes.

Aspects of the invention include methods for degrading one or more organic compounds using one or more electrochemical cells in any inventive permutation described herein. Such methods may comprise: subjecting the cathode and the anode to a potential to produce current densities in a range of 50 to 150 mA/cm² while producing bubbles comprising O₂ in the electrolyte solution comprising an organic compound, thereby generating hydroxyl radicals in the electrolyte solution which react with the organic compound, wherein at least 90 wt % of the organic compound, relative to a total initial weight of the organic compound, is degraded after subjecting for a time period of 10 to 20 min.

Such methods may comprise flowing a waste water through the electrochemical cell comprising the electrolyte solution. The bubbles comprising O₂ in inventive methods may be air bubbles.

Useful electrolyte solutions may comprise the organic compound at an initial concentration in a range of from 0.1 to 2.0 pg/mL electrolyte solution. Useful electrolyte solutions, or contaminated water sources, may comprise two or more organic compounds which are degraded in the method.

Aspects of the invention include methods of making an inventive catalyst in any inventive permutation described herein, the method comprising: calcining rice husks to produce rice husk ash; mixing the rice husk ash with an inorganic base to produce a silicate solution; mixing a structure directing agent with the silicate solution to produce a gel; contacting the gel with an inorganic acid and the Fe³ salt to produce a loaded gel; and washing and calcining the loaded gel to produce the composite catalyst. Useful structure directing agents may further comprise glycerol and a fatty acid ammonium halide.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 shows a schematic diagram of a droplet-impingement flow-assisted electro-Fenton reactor within the scope of the invention;

FIG. 2A shows N₂ sorption isotherms obtained from Barrett, Joyner, Halenda (BJH) adsorption of rice hull/husk silica (RHS)-x % Fe nanocomposites as described herein;

FIG. 2B shows pore size distribution obtained from BJH adsorption of RHS-x % Fe nanocomposites as described herein;

FIG. 3A shows a field emission scanning electron microscopy (FE-SEM) image of an exemplary RHS-0% Fe (nano)composite;

FIG. 3B shows an energy-dispersive X-ray (EDS) spectrum of an exemplary RHS-0% Fe (nano)composite;

FIG. 3C shows an FE-SEM image of an exemplary RHS-10% Fe (nano)composite;

FIG. 3D shows an EDS spectrum of an exemplary RHS-10% Fe (nano)composite;

FIG. 3E shows a transmission electron microscopy (TEM) image with an inset selected area electron diffraction (SAED) image of an exemplary RHS-0% Fe (nano)composite;

FIG. 3F shows a transmission electron microscopy (TEM) image with an inset SAED image of an exemplary RHS-10% Fe (nano)composite;

FIG. 4A shows an x-ray photoelectron spectroscopy (XPS) survey spectra for exemplary RHS-0% Fe and RHS-10% Fe nanocomposites as described herein;

FIG. 4B shows XPS results for the elemental composition of exemplary RHS-0% Fe and RHS-10% Fe nanocomposites as described herein;

FIG. 4C shows a high resolution XPS spectra for oxygen (O 1s) in an exemplary RHS-10% Fe (nano)composite;

FIG. 4D shows a high resolution XPS spectra for silicon (Si 1s) in an exemplary RHS-10% Fe (nano)composite;

FIG. 4E shows a high resolution XPS spectra for carbon (C 1s) in an exemplary RHS-10% Fe (nano)composite;

FIG. 4F shows a high resolution XPS spectra for iron (Fe 2p) in an exemplary RHS-10% Fe (nano)composite;

FIG. 5 shows plots correlating amounts of electrogenerated H₂O₂ as a function of time at room temperature, using a droplet-impingement flow-assisted electro-Fenton reactor /reaction as described herein;

FIG. 6 shows a plot comparing calculated versus experimental percentage average degradation for β-blockers using a Fenton reactor/reaction as described herein;

FIG. 7 shows central composite design (CCD) model residual plots for the percentage average degradation for the β-blockers acebutolol (ACE) and propranolol (PROP);

FIG. 8 shows a Pareto effects graphic analysis for the degradation (%) of the β-blockers acebutolol (ACE) and propranolol (PROP);

FIG. 9A shows contour plots of the degradation efficiency (%) as a function of catalyst concentration (mg/L) and reaction time (min);

FIG. 9B shows response surfaces of the degradation efficiency (%) as a function of catalyst concentration (mg/L) and reaction time (min);

FIG. 9C shows contour plots of the degradation efficiency (%) as a function of initial β-blocker concentration, [β-blocker]₀, and current density (mA/cm²);

FIG. 9D shows response surfaces of the degradation efficiency (%) as a function of initial β-blocker concentration, [β-blocker]₀, and current density (mA/cm²);

FIG. 9E shows contour plots of the degradation efficiency (%) as a function of electrolysis time (minutes) and pH;

FIG. 9F shows response surfaces of the degradation efficiency (%) as a function of electrolysis time (minutes) and pH;

FIG. 10 shows charts of degradation percentage for exemplary catalysts of varying Fe content;

FIG. 11 shows charts comparing degradation efficiency (% DE) of various Fenton techniques for a β-blocker sample solution at room temperature;

FIG. 12 shows representative decay plots of acebutolol (ACE) using different amounts of RHS/C-10% Fe catalyst as described herein; and

FIG. 13 shows a proposed reaction scheme for the degradation of propranolol (PROP) and acebutolol (ACE) upon treatment with .OH as described herein.

FIG. 14 shows x-ray diffraction (XRD) spectra for exemplary RHS-0% Fe and RHS-10% Fe nanocomposites as described herein.

### DETAILED DESCRIPTION OF THE PREFERRED EMBODIMENTS

Aspects of the invention provide heterogeneous catalysts, comprising: Fe³ ions in a range of, e.g., from 8 to 12 wt. % and/or at least 5, 6, 7.5, 8.5, 10, or 11 wt. % and/or up to 20, 17.5, 15, 12.5, 11, or 10 wt. %, based on total catalyst weight; and a support, making up the balance of the heterogeneous catalyst, comprising at least 75, 80, 85, 90, 92.5, 95, 97.5, 98, 99, 99.1, 99.5, or 99.9 wt. %, based on total support weight, of a mesoporous amorphous silica, the support being impregnated with the Fe³ ions, wherein the catalyst has a BET surface area in a range of, e.g., from 50 to 80 m²/g and/or at least 33.3, 40, 45, 50, 55, 57.5, 60, or 62.5 m²/g and/or up to 120, 110, 100, 90, 80, 75, 70, 65 or 62.5 m²/g, wherein the catalyst has an average pore diameter in a range of, e.g., from 4 to 10 nm and/or at least 2, 3, 4.5, 5, 6, or 7.5 nm and/or up to 20, 17.5, 15, 14, 13, 12.5, 12, 11, 10.5, 9.5, 8.5, or 7.5 nm, and wherein the mesoporous amorphous silica is produced by a process comprising calcining a mixture comprising a silicate and a structure directing agent comprising glycerol and a fatty acid ammonium halide, such as C10 to C20-alkyl trialkylammonium halide(s). The fatty acid ammonium halides may have a fatty acid chain with at least 10, 11, 12, 13, 14, or 15 and/or up to 20, 19, 18, 17, 16, or 15 carbon atoms and/or the ammonium may have, independently, e.g., 1, 2, or 3 methyl, ethyl, propyl, isopropyl, butyl, isobutyl, s-butyl groups, and/or halides may be, for example, chlorides, bromides, and/or iodides.

Aspects of the invention include electrochemical cells, comprising: a carbon-based cathode; an anode; a heterogeneous catalyst; an electrolyte solution in contact with the cathode, the anode, and the catalyst; and a source of gaseous oxygen configured to produce oxygen-containing bubbles in the electrolyte solution near the carbon-based cathode, wherein the catalyst comprises: Fe³⁺ ions in a range of, e.g., from 5 to 20 wt. % and/or at least 2.5, 3.3, 4.5, 5.5, 6.5, 7.5, or 8 wt. % and/or up to 25, 22.5, 21, 19, 17.5, 16, 15, 14, 13, 12, 11, 10, 9, 8, or 7.5 wt. %, based on total catalyst weight; and, representing the balance of the weight of the heterogeneous catalyst, a support comprising at least 75, 80, 85, 90, 91, 92, 92.5, 93, 94, 95, 96, 97, 97.5, 98, 99, 99.1, 99.5, or 99.9 wt. %, based on total support weight, of a mesoporous amorphous silica, the support being impregnated with the Fe³⁺ ions, whereby “impregnated” can generally mean that the iron ions may be on the surface of, and/or embedded within the matrix of, the support. The impregnation of the support may be preferably achieved, in certain applications, during the fabrication of the silica from a solution comprising silicate(s) and iron ions, e.g., with a structure directing agent that may comprise, for example, polyol(s) such as glycerol, ethylene glycol, erythritol, PEG, and/or PVA, and/or surfactant(s) including, e.g., fatty acid ammonium halide(s) as described herein (examples: cetrimonium bromide (CTAB), cetylpyridinium chloride (CPC), benzalkonium chloride (BAC), benzethonium chloride (BZT), dimethyldioctadecylammonium chloride, and dioctadecyldimethylammonium bromide (DODAB)), or fatty acid sulfates, carboxylates, sulfonates, (examples: sodium lauryl sulfate, ammonium lauryl sulfate, 3-[(3-cholamido-propyl)dimethylammonio]-1-propanesulfonate, 4-(5-dodecyl) benzenesulfonate, sodium stearate, dioctyl sodium sulfosuccinate, sodium myreth sulfate, sodium laureth sulfate).

Useful catalysts may have a BET surface area in a range of from 25 to 100 m²/g, such as at least 30, 35, 40, 45, 50, 55, 60, or 65 m²/g and/or up to 150, 135, 125, 120, 110, 105, 95, 90, 85, 80, 75, 70, 67.7, 65 or 62.5 m²/g. Likewise or alternatively, useful catalysts may have an average pore diameter in a range of from 2 to 20 nm and/or at least 2.5, 3, 3.3, 4.5, 5.5, 6.5, 7.5, or 8 nm and/or up to 25, 22.5, 21, 19, 17.5, 16, 15, 14, 13, 12, 11, 10, 9, 8, or 7.5 nm. The catalyst(s) may be present in the electrolyte solution in a range of from 50 to 200 pg/mL electrolyte solution and/or at least at least 25, 35, 45, 55, 60, 65, 70, 75, 80, 85, 90, 95, 100, 105, 110, 115, or 120 pg/mL and/or up to 250, 225, 210, 190, 185, 180, 175, 170, 165, 160, 155, 150, 145, 140, 135, 130, 125, or 120 pg/mL.

Useful mesoporous amorphous silicas for the support may be made by a process comprising: contacting a silicate with a structure directing agent comprising glycerol, to obtain a mixture comprising the silicate and the glycerol; and calcining the mixture for at least 1, 2, 3, 4, 5, 6, 7, or 8 hours and/or no more than 18, 14, 12, 10, 8, or 6 hours, at a temperature in a range of from 500 to 1000° C., e.g., at least 550, 600, 625, 650, 675, 700, 725, 750° C. and/or no more than 1250, 1100, 950, 900, 850, 825, 800, 775, 750, 725, or 700° C. Useful structure directing agents may further comprise further polyols(s) and/or surfactant(s) such as fatty acid ammonium halide(s) as described above.

Anodes useful in the invention may be silicon/boron-doped diamond anodes and/or cathodes useful in the invention may be polymer-based graphite felt electrodes. Potential polymers upon which the graphite felt electrodes may be based may be PAN, PE-PVA, PE, PP, PS, polyamide, polyester, and/or mixtures thereof and/or copolymers comprising monomers of these in polymerized form. Depending upon the scale of the electrochemical cell, the surface area of the anode(s) and/or cathode(s) may be at least 4, 5, 7.5, 10, 15, 25, 50, 100, 200, 250, 500, 1000, 2500, 5000, or 10000 cm², as is technically feasible, whereby arrays of at least 5, 10, 15, 20, 25, 50, 100, 250, 500, or 1000 pairs of electrodes may be used in larger cells.

Aspects of the invention provide methods, comprising: passing water comprising an organic compound, e.g., wastewater from a hospital, chemical plant, mill, textile factory, refinery, and/or municipality, through one or more electrochemical cells in any inventive permutation described herein, thereby subjecting the organic compound, such as pharmaceuticals, dyes, shampoos, conditioners, soap residues, lubricants, and/or to a droplet-impingement, flow-assisted Fenton reaction to degrade the organic compound, i.e., generally supplying a source of gaseous oxygen, such as air or concentrated O₂ in some form, wherein the passing reduces a content of the organic compound in the water by at least 90, 91, 92, 92.5, 93, 94, 95, 96, 97, 97.5, 98, 99, 99.1, 99.5, or 99.9 wt. % from an inlet of the cell to an outlet of the cell within 20, 18, 16, or 15 minutes, and usually more than 5, 6, 7, 8, 9, or 10 minutes.

Aspects of the invention include methods for degrading one or more organic compounds, e.g., 2, 3, 4, 5, 7, 10, 15, 20, or more organic compounds, using one or more electrochemical cells in any inventive permutation described herein. Depending upon the flow and/or volume to be treated, as well as the volume of the cells employed, 5, 10, 25, 50, 100, 250, 500, or 1000 cells may be used, in parallel, series, or a mixture thereof. Such methods may comprise: subjecting the cathode and the anode to a potential to produce current densities in a range of 50 to 150 mA/cm², e.g., at least 35, 45, 55, 60, 75, or 100 mA/cm² and/or up to 175, 165, 155, 145, 140, 135, 130, or 125 mA/cm² (any range described herein), while producing bubbles comprising O₂ in the electrolyte solution comprising an organic compound, thereby generating hydroxyl radicals in the electrolyte solution which react with the organic compound, wherein at least 90, 92.5, 95, 97.5, 98, 99, 99.1, 99.5, or 99.9 wt % of the organic compound, relative to a total initial weight of the organic compound, is degraded after subjecting for a time period of 10 to 20 minutes, e.g., at least 8, 9, 11, 12, 13, 14, or 15 minutes and/or up to 25, 22.5, 19, 17.5, 16, 15.5, 15, 14, 13, or 12 minutes (any range described herein).

Such methods may comprise flowing a waste water, such as a municipal waste water, hospital waste water, chemical plant waste water, or the like, through the electrochemical cell comprising the electrolyte solution. The bubbles comprising O₂ in inventive methods may be air bubbles. The O₂ may be from multiple sources, such as air, enriched O₂ gases, or pure O₂.

Useful electrolyte solutions may comprise the organic compound(s) at an initial concentration in a range of from 0.1 to 2.0 pg/mL electrolyte solution, e.g., at least 25, 50, 100, 150, 250, 500 ng/mL and/or up to 5, 4, 3, 2.5, 1.5, 1, 0.9, 0.8, 0.75, 0.7, or 0.65 sg/mL (any range described herein), either collectively or individually. Useful electrolyte solutions, or contaminated water sources, may comprise two or more organic compounds which are degraded in the method, e.g., 3, 4, 5, 6, 7, 10, 15, 20, 25, 30, 50, 100, or more compounds.

Aspects of the invention include methods of making an inventive catalyst in any inventive permutation described herein, the method comprising: calcining rice husks to produce rice husk ash; mixing the rice husk ash with an inorganic base, such as sodium, potassium, lithium, ammonium, etc., hydroxide and/or (bi)carbonate, to produce a silicate solution; mixing a structure directing agent with the silicate solution to produce a gel; contacting the gel with an inorganic acid and the Fe salt to produce a loaded gel; and washing and calcining the loaded gel to produce the composite catalyst. Useful structure directing agents may comprise, e.g., polyols(s) as described herein, such as glycerol and/or surfactant(s) as described herein, such as fatty acid ammonium halide, e.g., a C10 to C20-alkyl trialkylammonium halide. While the rice husks, or ash from them, may be a source of the silica and/or silicate percursor, as well as any carbon-based binder material in the support, synthetic or natural silicates of any kind may be implemented in part or in whole, to make the support.

Inventive Fenton processes, and inventive cells conducting them and/or catalysts enabling them, may be conducted at a pH of at least 3, 4, 5, 6, or 7, and/or below 10, 9.5, 9, 8.5, 8, 7.5, or 7. Temperatures for the degradation may be at least 5, 10, 12.5, 15, 17.5, 20, 22.5, 25, or 30° C. and/or up to 100, 90, 80, 70, 60, 50, 45, 40, 35, 30, 25, and/or 20° C., though ambient temperature may be preferred in many circumstances. Manageable flow rates generally depend upon the electrochemical cell set up, and may be, for example, at least 1, 2.5, 5, 10, 15, 25, 50, 100, 250, 500, 1000, 2500, 5000, 1×10⁴, 1×10⁵, or 1×10⁶ L/s, and/or up to 1×10¹⁰, 1×10⁹, 1×10⁸, 1×10⁷, 1×10⁶, 1×10⁵, 1×10⁴, 1000, 500, 250, or 100 L/s.

Inventive heterogeneous catalysts may exclude or contain no more than 15, 10, 7.5, 5, 4, 3, 2, 1, 0.5, 0.1, 0.01, 0.001, or 0.0001 wt. %, relative to the total active metal weight in the Fenton catalyst, of Mg and/or Cu.

Exemplary beta blockers subject to degradation may include acebutolol hydrochloride (Sectral), atenolol (Tenormin), betaxolol hydrochloride (Kerlone), bisoprolol fumarate (Zebeta), carteolol hydrochloride (Cartrol), esmolol hydrochloride (Brevibloc), metoprolol (Lopressor, Toprol XL), penbutolol sulfate (Levatol), nadolol (Corgard), nebivolol (Bystolic), pindolol (Visken), propranolol (Inderal, InnoPran), timolol maleate (Blocadren), sotalol hydrochloride (Betapace), carvedilol (Coreg), and/or labetalol hydrochloride (Trandate, Normodyne), though the class of pharmaceutical (or other organic contaminant in water) subject to degradation is generally unlimited. Further examples of classes of drugs subject to degradation may include antipyretics, analgesics, antimalarials, antibiotics, antiseptics, anticoagulants, antidepressants, anticancer drugs, antiepileptics, antipsychotics, antivirals, sedatives, antidiabetic, hormone replacements, oral contraceptives, stimulants, tranquilizers, statins, or mixtures of two or more of any of these. Beyond beta blockers, relevant compound classes may include 5-alpha-reductase inhibitors, angiotensin II receptor antagonists, ACE inhibitors, alpha-adrenergic agonists, dopamine agonist, dopamine antagonist, incretin mimetics, nonsteroidal anti-inflammatory drugs—cyclooxygenase inhibitors, proton-pump inhibitors, renin inhibitors, selective glucocorticoid receptor modulators, selective serotonin reuptake inhibitors, or mixtures of two or more of any of these. Biopharmaceuticals, such as antibodies, proteins, nucleotide sequences/splices, etc., may also be degraded.

Fenton reaction methods, i.e., degradations, according to the invention may be equally effective with or without irradiation, and may exclude, for example, UV, visible, IR, and/or other wavelengths of light as desired. Inventive systems can operate without photovoltaic devices, films, cells, and/or materials. Materials of the invention may remediate water—removing organic impurities—without using magnetism and/or without being magnetic. Inventive processes may remediate water without employing absorption and/or absorption and/or abstraction.

Aspects of the invention provide droplet-impingement, flow-assisted electro-Fenton (DFEF) system, which may be useful in degrading organic materials, pharmaceuticals, and the like, which are contaminating water and aqueous solutions (or even organic solutions with sufficient solubility). Inventive systems may be used to degrade mixtures of β-blockers in hospital wastewater, which may be followed by LC-MS/MS. Air pump(s) may be used to generate a spray impingement flow at the anode surface. The entire sample matrix may be continuously saturated with natural air. Sol-gel synthesized, iron loaded, (optionally biogenic) silica-carbon nanocomposites (RHA/C-x % Fe) may be used as the heterogeneous catalysts, though the origin of the silica need not be restricted. The two drugs studied in the examples were acebutolol (ACE) and propranolol (PROP), though the degradation technique may be broadly applied to organic contaminants, and major intermediate species formed during degradation may be elucidated, if desired, using LC-MS/MS.

Unexpectedly superior features of the inventive approach include a synergistic effect of droplet-impingement at the cathode resulting in fast kinetics in continous electrogeneration of hydroxyl radicals. In addition, inventive approaches can implement low-cost biogenic silica composite catalyst(s) as an iron source and/or micro-electrolytic carbon source. Inventive approaches can likewise employ an air pump to generate spray droplet flow at the cathode and/or to continuously saturate the entire sample matrix with natural air.

Aspect of the invention provide a heterogeneous droplet-impingement flow-assisted electro-Fenton (DFEF) system catalyzed by, e.g., rice husk-derived, silica supported iron composite catalysts, which can degrade organic material, such as β-blockers, in contaminated water, such as hospital wastewater. Three unexpected advantages of this “green” approach have been determined. Firstly, there is a synergistic effect of using droplet-impingement at the cathode, resulting in fast kinetics for generating hydroxyl radicals, while tolerating or even preferably using a low cost, yet reusable, biogenic silica for a composite catalyst serving as an iron and micro-electrolytic carbon source. Secondly, the system's ability to perform the electro-Fenton process without pH confinement of at most 3, i.e., at natural pH, since the biogenic iron composite source provides a suitable pH for the Fenton reaction. Thirdly the incorporation of response surface methodology based on central composite design (CCD) provides adequate process optimization at minimal experimental runs. It was demonstrated in the validation step that the experimental data were in good agreement with the theoretical values. A comparison study indicates that the DFEF treatment mode is superior to other known degradation approaches. The concentration decay kinetics of both propranolol (PROP) and acebutolol (ACE) follow pseudo-first-order kinetics, achieving complete degradation within 15 minutes of DFEF treatment.

### EXAMPLES

CHEMICAL AND MATERIALS: All chemicals described herein were of analytical grade quality and were used as received without further purification. Acebutolol hydrochloride (ACE, at least 98% pure) and propranolol hydrochloride (PROP, at least 99% pure) were purchased from Sigma-Aldrich (Deisenhofen, Germany). Ferric nitrate, Fe(NO₃)₃.9H₂ (98.5%), cetyltrimethylammonium bromide (CTAB), nitric acid, sodium hydroxide, sulfuric acid, hydrochloric acid, acetone, sodium chloride, and glycerol were purchased from Sigma-Aldrich (St. Louis, USA). Acetonitrile, formic acid, and methanol (LC-MS grade) were purchased from Fisher Scientific (Schwerte, Germany). In all experiments, a 0.05 M Na₂SO₄ solution was used as a supporting electrolyte. An Si/BDD electrode with 2.75 μm BDD thin layer thickness (both sides) deposited on a conductive Si sheet, was purchased from NeoCoat (Switzerland). A graphite felt electrode (GFE) based on 5 mm thick PAN was purchased from Shanghai Qijie Limited Co. (China).

The pH of the sample solutions was adjusted using 1M NaOH and H₂SO₄ (3 M). RHS/C-x % Fe composites were investigated as heterogeneous electro-catalysts. Rice husk used as a biogenic silica precursor was secured from a rice mill (Kerala, India). Ultrapure water processed from Milli-Q system (conductivity <6×10⁻⁸ S/cm) (Milford, Mass., USA) was used for all the experiments. Syringe filters of 0.2 μm pore size were obtained from Sigma Aldrich. Beta (β)-blockers standard stock solutions of 1000 mg/L were prepared in methanol while mixed drug working solutions were prepared weekly by appropriate dilutions of a series of low concentrations of standard solutions in Milli-Q water. The study was conducted on hospital wastewater collected from King Fahd University of Petroleum and Minerals Medical Center.

CATALYST SYNTHESIS: Milled rice husk (RH, 45 g) was placed in a beaker containing 400 g of distilled water and 15 g of sulfuric acid under constant stirring for 3 hours and at 80° C. for washing. This washing stage rids the rice husks (RH) of adhered soil /dirt and reduces dissolved metallic impurities to negligible levels. The solid residues were then separated by filtration, washed with copious amount of deionized water until neutral in pH, then oven dried at 110° C. overnight. Subsequently, the residues were calcined in a muffle furnace at 700° C. for 8 hours to obtain 15% of the original material weight as rice husk ash (RHA). The dried RHA is mixed with 500 mL of 1M NaOH, stirred vigorously for 5 hours at 80° C. to obtain a sodium silicate solution, as a dark brown solution, that was later filtered and kept for subsequent use. CTAB and glycerol (each 2 wt. %) were dissolved in water/ethanol (1:1) solvent, added to sodium silicate solution and the mixture was stirred at 60° C. until dissolution. Both CTAB and glycerol can act as structure directing agents, and glycerol can also act as a capping agent ensuring stable nano-sized particles at high calcination temperature while enhancing the increment of functional moieties on the rice husk silica (RHS) sol for anchoring loaded metals. The resultant sodium silicate solution obtained was then titrated slowly with 3.0 M HNO₃ containing the appropriate mass of Fe(NO₃)₃.9H₂O to reach 5, 10, or 20 wt. % of Fe, until reaching a pH of 4.0. The resulting solution/gel was aged at room temperature for 48 hours. The gel was recovered by centrifugation (Eppendorf centrifuge 5430, Hamburg, Germany) at 4000 rpm, washed thoroughly with distilled water, and dried in an oven at 110° C. for 18 hours. The nanocomposite catalysts were finally calcined for 5 hours and at 700° C. to remove CTAB and yield the final products. The solid products obtained were ground and labeled as iron loaded rice husk silica/carbon composites, RHS/C-x % Fe, where x is 0, 5, 10, or 20 wt. % Fe, with zero signified no iron loading. Iron loadings may be any of these or at least 2.5, 4, 6, 7, 7.5, 8, 9, 11, 11.5, 12, 12.5, 13.3, 14, 14.5, or 15 wt. % and/or 25, 22.5, 21, 19, 18, 17.5, 17, 16.5, 16, 15.5, 15, 14.5, or 14 wt. %, based on total catalyst weight.

CATALYST CHARACTERIZATION: The pore volume and size of the heterogeneous catalysts were measured on micromeritics and porosimetry analyzer (Micromeritics, ASAP2020, and USA) using liquid N₂ adsorption-desorption at −196° C. by the Barrett-Joyner-Halenda (BJH) method. A field emission scanning electron microscope, FE-SEM (Tescan Lyla 3, USA), under a 15 kV acceleration voltage and energy-dispersive X-ray, EDX (Tescan Lyla 3, USA) was used for identification of the surface morphology and elemental composition of the prepared heterogeneous catalysts. X-ray photoelectron spectroscopy (XPS) and selected area electron diffraction (SAED) techniques were used to study the chemical and phase composition of the heterogeneous catalysts. The chemical bonding features and elemental composition of the synthesized rice husk based catalysts were characterized by XPS under monochromatized AlKα (hv=1486.6 eV) radiation. X-ray diffraction (XRD) analysis was conducted on nanocomposites synthesized as described herein at a continuous scan rate of 0.5°/min, 0.02° scan size and the Bragg's angle (20) range of 10 to 80°. Transmission electron microscopy (TEM) was used to estimate the particle size, metal particle distribution and iron particles distribution on rice husk silica/carbon support.

LC/MS/MS SYSTEM AND ANALYSIS: Ultra-high-performance liquid chromatograph triple quadrupole mass spectrometry (LCMS-8050, Shimadzu) was used in monitoring the degradation process. Data acquisition and quantification were conducted with LabSolutions LCMS Ver. 5.6, Shimadzu, (Kyoto, Japan). The liquid chromatography (LC) instrument included an auto sampler, CTC-Pal (Analytics AG, Zwingen, Switzerland), two pumps, Shimadzu, and a 50 mL sample loop. Chromatographic separation of the β-blockers was carried out on an Ultra IBD column (100×2.1 mm×3 μm particle size; Restek, Bellefonte, Pa., USA) maintained at 40±1° C. Gradient elution with solvent A (0.03% formic acid) and solvent B (methanol/acetonitrile, 25:75) at a flow rate of 0.3 mL/min was used. The starting gradient was 10.0% of mobile phase B with a hold time of 0.5 minutes and was increased to 25% at 3.0 minutes, then to 30% at 3.5 minutes with a hold time of 0.5 minutes. From there, the elution was linearly ramped to 90% for another 0.5 min then again to 10% in another 0.5 minutes and 0.5 minutes was used for column stability and equilibration. The injection volume was 10 μL. The ions of target analytes were detected in multiple reaction (MRM) mode, through transition monitoring of precursor ions of acebutolol (ACE) m/z 337 and propranolol (PROP) m/z 260 to product ions m/z 319.35-116 and m/z 183.25-116.2 for acebutolol (ACE) and propranolol (PROP), respectively. The MRM compound optimized parameters for propranolol (PROP) and acebutolol (ACE), viz., entrance potential (EP), declustering potential (DP), collision energy (CE), and collision cell exit potential (CXP) were 10, 22, 21, 19 and 10, 20, 22, 20 respectively. To identify the reaction intermediates, a Q3 scan (mass range, m/z, 60-600) was first performed, followed by a product ion scan of the suspected reaction intermediate and eventually a multiple reaction mode (MRM) scan.

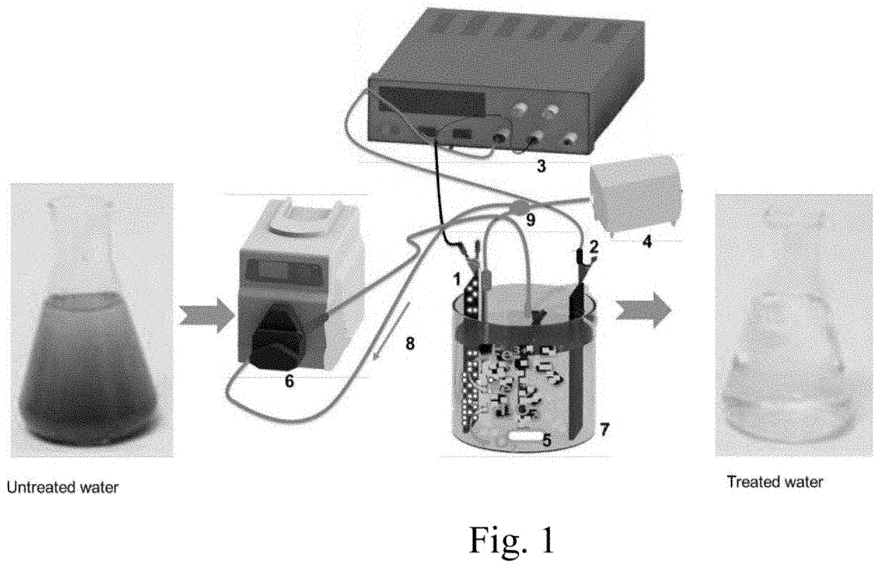

DROPLET-IMPINGEMENT FLOW-ASSISTED ELECTRO-FENTON SYSTEM: Hydrogen peroxide electrogeneration experiments were performed in a 500 mL open and undivided cylindrical reactor suitable for a working solution of 0.21 L and Fe—RHS/C composite catalysts, designed to suite a droplet-impingement flow-assisted electro-Fenton mode. FIG. 1 shows a schematic diagram of an exemplary droplet-impingement flow-assisted electro-Fenton reactor used in this study. Silica/boron-doped diamond (Si/BDD) was used as anode while the cathode was graphite felt electrode (GFE), both the cathode and anode having a surface area of 4 cm² and connected to a direct current power supply (Sargent Welch Scientific Ac/dc Power Supply, 0-22V, 4A) and a digital multimeter (auto range AC/DC voltage/current, Fluka) that supplied and measured the required current. Both electrodes were placed at a distance of 1 cm from the bottom of the reactor and the inter electrode gap maintained at 3 cm. Prior to every experiment, electrodes surfaces were cleaned and preconditioned with acetone and 35% HCl for 5 min and then rinsed with double distilled water.

An air pump connected to the sample flow system (at junction 9, FIG. 1) was used to generate a droplet spray of solution at the cathode surface and saturate the entire sample solution with dissolved oxygen needed for oxygen reduction reactions to generate hydrogen peroxide (Table 1, reaction 1). For all the experiments, the sample solution was stirred magnetically. Electrolytic degradation experiments were performed using initial β-blockers concentrations of 200 to 1000 ng/mL in 0.050 M Na₂SO₄ with defined amounts of rice husk-based silica/carbon-iron (RHS/C-x % Fe) as heterogeneous composite catalysts ranging between 23.8 to 214.3 mg/L, at a sample pH of 3 (to un-adjusted pH), room temperature, and a constant current densities ranging from 25 to 125 mA/cm². Useful current densities may be, for example, at least 20, 25, 30, 35, 40, 45, 50, 55, 60, 65, 70, or 75 mA/cm² and/or up to 150, 135, 130, 125, 115, 110, 10⁵, 95, 90, 85, 80, or 75 mA/cm². For subsequent experiments, the sample solution pH was adjusted to desired values using NaOH or H₂SO₄ with a benchtop pH-meter (ThermoFisher Scientific) having a combined glass electrode. Samples were withdrawn from the electrolytic cell after a certain time interval, filtered with syringe filters of 0.2 μm pore size prior to LC/MS/MS analysis. A sketch of the flow-assisted, droplet-impingement electro-Fenton reactor used in the examples herein is shown in FIG. 1.

EVALUATION OF DEGRADATION RATE AND ELECTROGENERATION OF HYDROGEN PEROXIDE: The degradation rate was measured in terms of percentage degradation of the organic material using the LC-MS/MS. To identify β-blocker degradation intermediates, samples were analyzed after 10 minutes of electrolysis under optimized degradation conditions for a droplet-impingement, flow-assisted electro-Fenton (DFEF) reaction. To evaluate the electro-Fenton degradation efficiency (%), the concentration of acebutolol (ACE) and propranolol (PROP) in the sample solution was evaluated before and after measuring degradation. The degradation efficiency (% degradation) was evaluated using the Equation 10, below:

$$Degradation = ( 1 - \frac{A}{{A}_{0}} ) \times 100 , \qquad Eq . 10$$

wherein A₀ and A represent β-blocker concentration at time “0” and “t” respectively.

The electro-generation of H₂O₂ at the cathode by the inventive system was evaluated using potassium titanium (IV) oxalate method described in Analyst. 1980, 105, 950-954, which is incorporated herein by reference in its entirety. Briefly, 1 mL of filtered samples withdrawn from the electrolytic cell at regular time intervals was diluted with 1 mL of deionized water (each) followed by addition of 4 mL titanium regent, potassium titanium (IV) oxalate/H₂SO₄. The sample mixture was mixed thoroughly for 5 minutes to allow the development of an intense yellow complex of pertitanic acid with H₂O₂ present. The samples were then analyzed using UV-vis spectroscopy at a wavelength of 400 nM.

CENTRAL COMPOSITE DESIGN (CCD): A CCD approach was used to investigate the effect of five main parameters including: (i) the initial β-blocker concentration, [β]₀ (X₁); (ii) heterogeneous catalyst concentration, Cat (X₂); (iii) current density, CD (X₃); (iv) electrolysis time, ET (X₄); and (v) sample pH (X₅), on effective degradation of β-blockers by a DFEF with RHS/C-x % Fe. Each parameter was evaluated at a five coded level standard (−2, −1, 0, +1, +2) with (−), (0) and (+), respectively corresponding to low, middle, high levels. Thirty two randomized experiments consisting of 10 axial, 16 cube, and 6 replications at center point, based on levels and ranges of independent variables (design table and responses) with the experimental and predicted degradation responses expressed in percentage. The details of the CCD parameters, levels, and ranges are presented in Table 2. All the experiments performed in triplicate with the mean values presented.

TABLE 2
The CCD experimental design of independent test
variables and design table of average β-blocker
degradation (%) in the DFEF reactor system.

| | | | | | | | | | Calcu- |
|---|---|---|---|---|---|---|---|---|---|
| | | | | | | | | | lated % |
| | | | | | | Experimental % | | | Degra- |
| | | | | | | degradation | | | dation |
| Run | X1 | X2 | X3 | X4 | X5 | PROP | ACE | AVE | AVE |
| 1 | 600 | 119 | 75 | 15 | 5 | 78.19 | 84.73 | 81.46 | 80.66 |
| 2 | 600 | 119 | 75 | 15 | 5 | 77.47 | 84.03 | 80.75 | 80.66 |
| 3 | 200 | 119 | 75 | 15 | 5 | 90.16 | 96.46 | 93.31 | 96.02 |
| 4 | 260 | 115 | 75 | 15 | 5 | 77.92 | 84.48 | 81.20 | 80.66 |
| 5 | 400 | 71.4 | 100 | 20 | 6 | 93.09 | 99.35 | 96.22 | 95.07 |
| 6 | 400 | 71.4 | 50 | 20 | 4 | 88.41 | 94.75 | 91.58 | 89.87 |
| 7 | 800 | 71.4 | 100 | 20 | 4 | 77.05 | 83.61 | 80.33 | 81.62 |
| 8 | 1000 | 119 | 75 | 15 | 5 | 85.43 | 91.83 | 88.63 | 85.88 |
| 9 | 600 | 119 | 25 | 15 | 5 | 62.13 | 68.99 | 65.56 | 68.81 |
| 10 | 600 | 214.3 | 75 | 15 | 5 | 58.57 | 65.51 | 62.04 | 57.16 |
| 11 | 800 | 71.4 | 50 | 20 | 6 | 68.38 | 75.12 | 71.75 | 70.33 |
| 12 | 800 | 71.4 | 50 | 10 | 4 | 33.03 | 40.47 | 36.75 | 35.50 |
| 13 | 600 | 119 | 125 | 15 | 5 | 90.28 | 96.58 | 93.43 | 90.13 |
| 14 | 400 | 166.7 | 50 | 20 | 6 | 78.15 | 84.69 | 81.42 | 81.06 |
| 15 | 600 | 119 | 75 | 5 | 8 | 27.64 | 35.18 | 31.41 | 33.20 |
| 16 | 800 | 71.4 | 100 | 10 | 6 | 58.36 | 65.30 | 61.83 | 61.13 |
| 17 | 400 | 166.7 | 50 | 10 | 4 | 53.69 | 60.73 | 57.21 | 57.02 |
| 18 | 600 | 119 | 75 | 15 | 5 | 76.50 | 83.08 | 79.79 | 80.66 |
| 19 | 600 | 23.8 | 75 | 15 | 5 | 31.11 | 38.59 | 34.85 | 39.68 |
| 20 | 600 | 119 | 75 | 15 | 3 | 75.90 | 82.50 | 79.20 | 77.02 |
| 21 | 600 | 119 | 75 | 15 | UN | 75.41 | 82.01 | 78.71 | 80.84 |
| 22 | 800 | 166.7 | 100 | 10 | UN | 54.92 | 61.92 | 58.42 | 61.23 |
| 23 | 600 | 119 | 75 | 15 | 5 | 76.02 | 82.60 | 79.31 | 80.66 |
| 24 | 800 | 166.7 | 50 | 20 | 4 | 79.16 | 85.68 | 82.42 | 84.50 |
| 25 | 400 | 166.7 | 100 | 20 | 4 | 88.28 | 94.62 | 91.45 | 93.81 |
| 26 | 400 | 71.4 | 50 | 10 | 6 | 42.81 | 50.05 | 46.43 | 42.73 |
| 27 | 400 | 166.7 | 100 | 10 | 6 | 68.18 | 74.92 | 71.55 | 71.92 |
| 28 | 800 | 166.7 | 50 | 10 | 6 | 54.93 | 61.93 | 58.43 | 58.53 |
| 29 | 800 | 166.7 | 100 | 20 | 6 | 83.21 | 89.65 | 86.43 | 89.07 |
| 30 | 600 | 119 | 75 | 15 | 5 | 78.14 | 84.68 | 81.41 | 80.66 |
| 31 | 400 | 23.8 | 100 | 10 | 4 | 48.41 | 55.55 | 51.98 | 51.00 |
| 32 | 600 | 119 | 75 | 30 | 5 | 93.49 | 99.73 | 96.61 | 94.77 |

AVE-represents average percentage degradation for both acebutolol (ACE) and propranolol (PROP) while UN- represents no pH adjustment.

Minitab software (Minitab Inc., State College, Pa., USA) was used in the construction of experimental design (CCD), mathematical modeling of the data, regression analysis, and optimization. The experimental results were then fitted with a second order polynomial in Equation 11 to correlate the relationship between independent variables with % β-blocker degradation responses.

$$Y ( coded value ) = 80.66 - {1.27 [ β ]}_{0} + 2.18 Cat + 2.6 CD + 7.7 ET + 0.48 pH + {0.64 [ β ]}_{0}^{2} - 2.01 {Cat}^{2} - 0.07 {CD}^{2} - 1.04 {ET}^{2} - 0.11 {pH}^{2} + {0.31 [ β ]}_{0} \times Cat + {0.05 [ β ]}_{0} \times CD - {0.44 [ β ]}_{0} \times ET + {0.27 [ β ]}_{0} \times pH - 0.24 Cat \times CD - 10.73 Cat \times ET - 0.11 Cat \times pH - 0.28 CD \times ET + 0.68 CD \times pH - 0.69 ET \times pH \qquad Eq . 11$$

wherein Y is the average percentage n-blocker degradation for both propranolol (PROP) and acebutolol (ACE), [β]₀ is the initial concentration of β-blocker, Cat is the catalyst concentration, CD is current density, ET is extraction, and pH is sample pH.

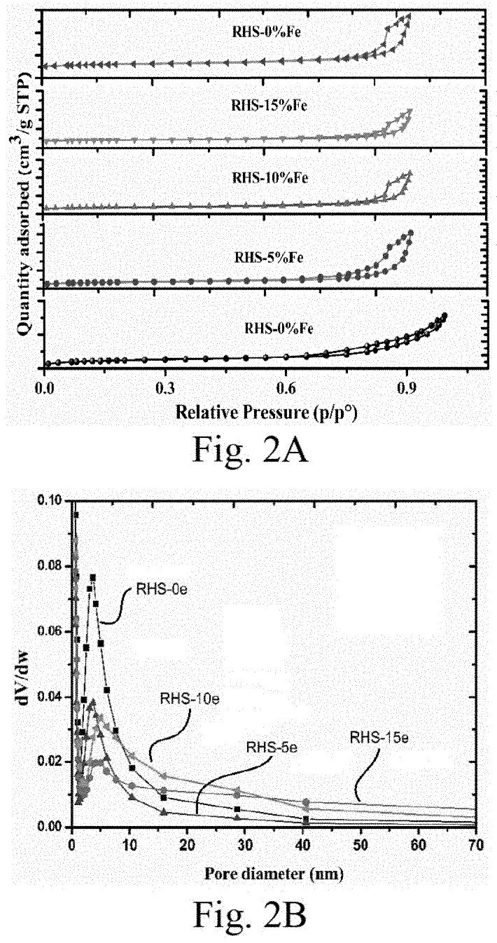

SYNTHESIZED HETEROGENEOUS CATALYST: Different techniques were used to characterize the synthesized nanocomposite catalysts. FIG. 2A shows the N₂ adsorption-desorption isotherms of the synthesized nanocomposites, which exhibit classical type IV isotherms with H3-type hysteresis loops under the IUPAC classification, typical of mesoporous compounds. FIG. 2B shows pore distribution curves for exemplary nanocomposites, indicating well-defined pore structure, with pore volume decreasing with increasing iron loading, and pore diameter increasing in a similar trend.

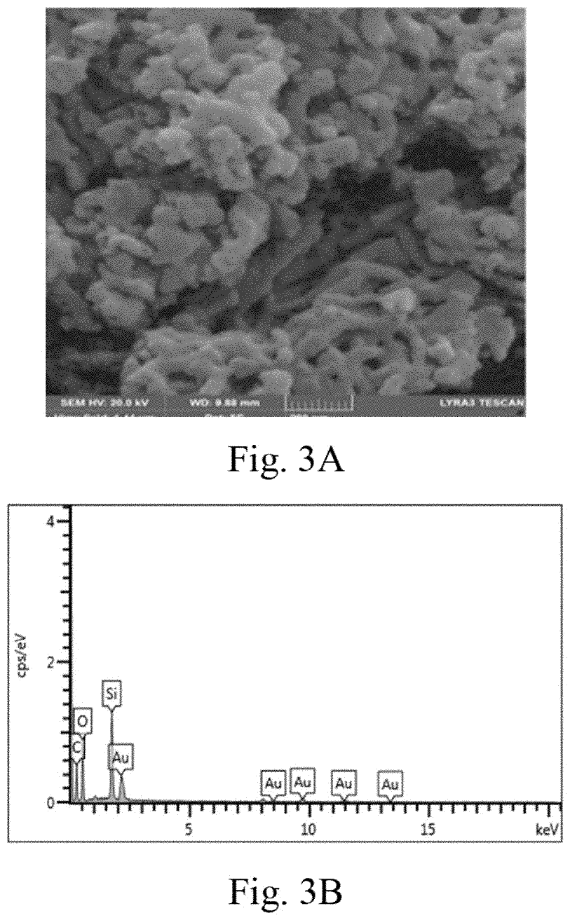

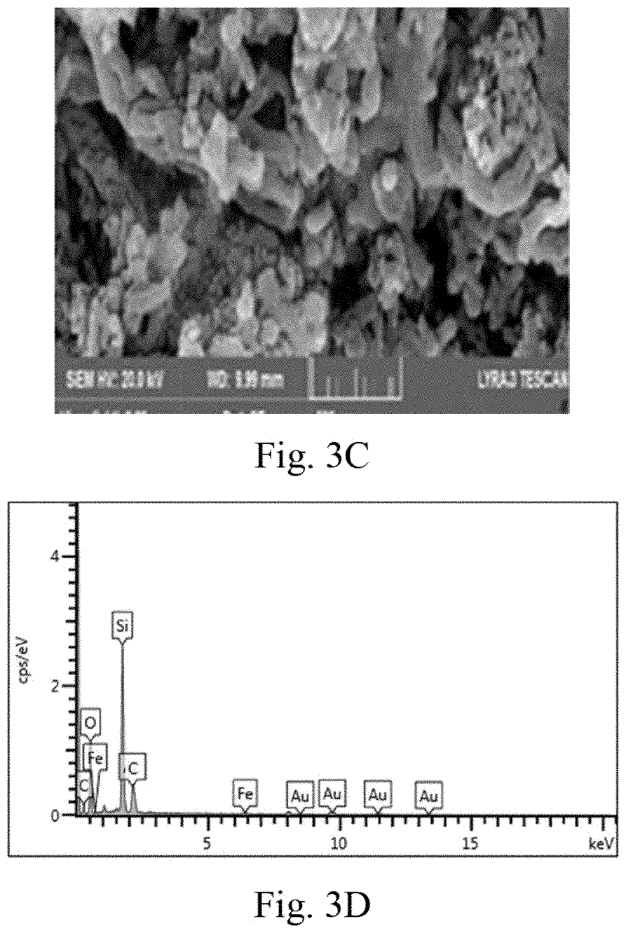

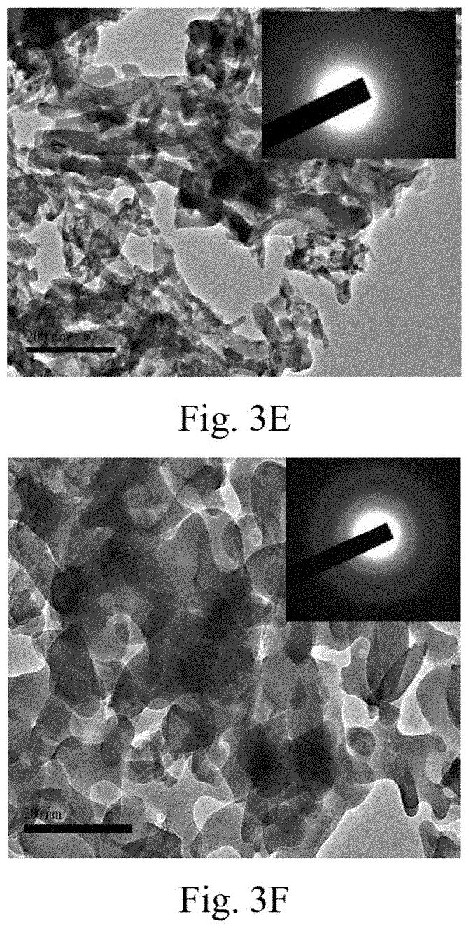

FIGS. 3A and 3B show field emission scanning electron microscopy (FE-SEM) images with inset energy-dispersive x-ray (EDX) spectra of RHS—O % Fe (FIG. 3A) and RHA-10% Fe (FIG. 3B). FIGS. 3C and 3D show transmission electron microscope (TEM) images with inset selected area electron diffraction (SAED) of RHS-0% Fe (FIG. 3C) and RHA-10% Fe (FIG. 3D), confirming the absence of crystalline portions in both samples and their amorphous structures.

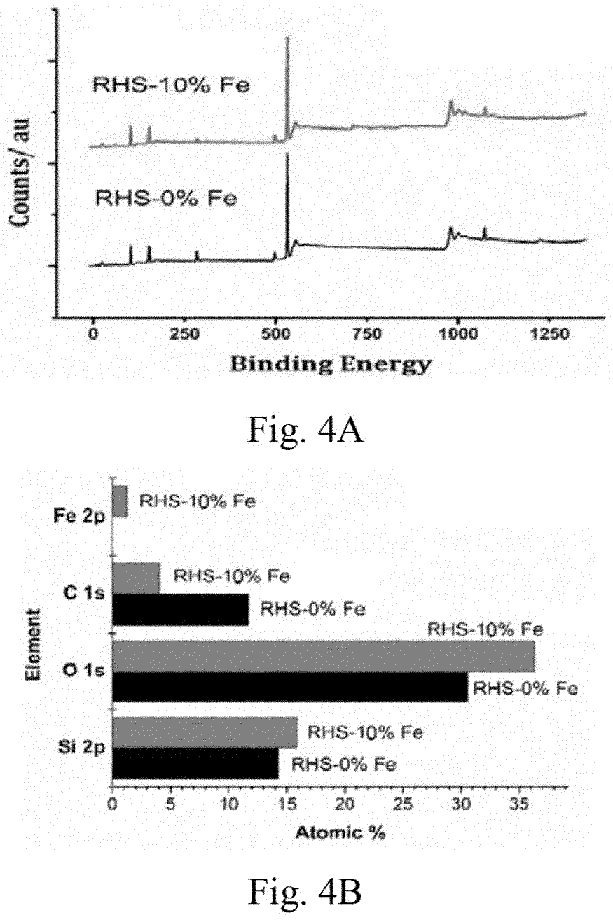

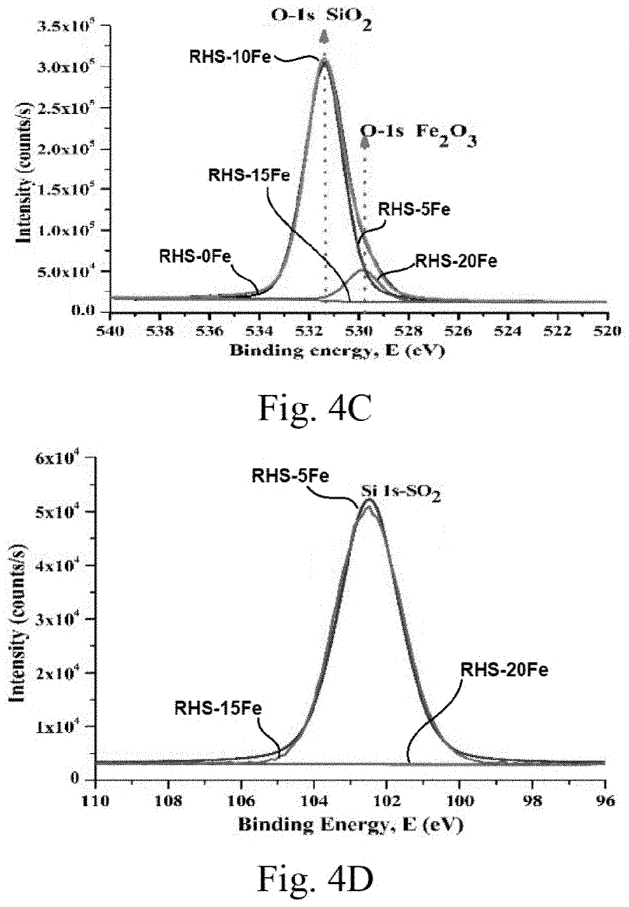

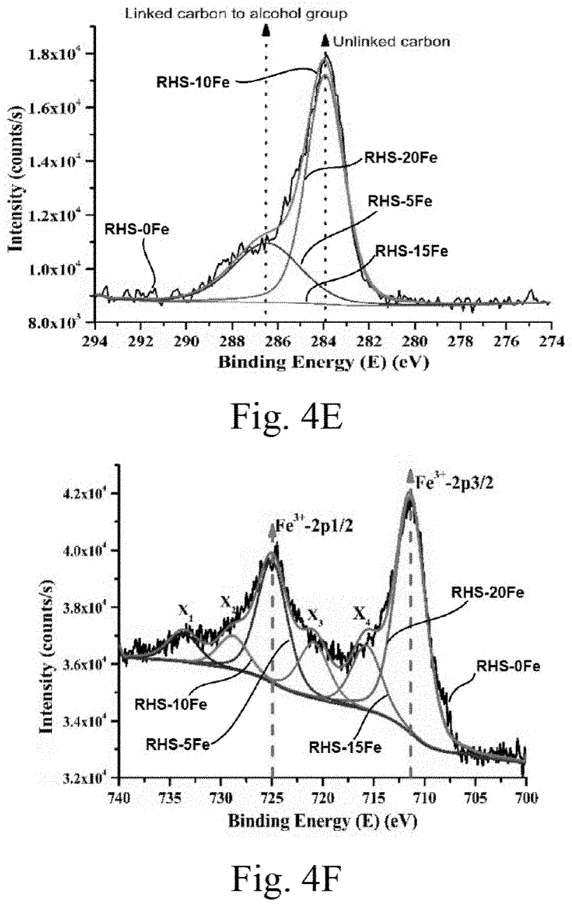

FIG. 4A to 4F show x-ray photoelectron spectroscopy (XPS) spectra of the nanocomposites, including a survey spectrum in FIG. 4A (for RHS-0% Fe and RHS-10% Fe) and high resolution scans for FIG. 4C to 4F. FIG. 4B charts the results for XPS elemental analysis of the survey spectra based on C-1s, O-1s, Si-1s, and Fe-2p for RHS-0% Fe and RHS-10% Fe catalysts.

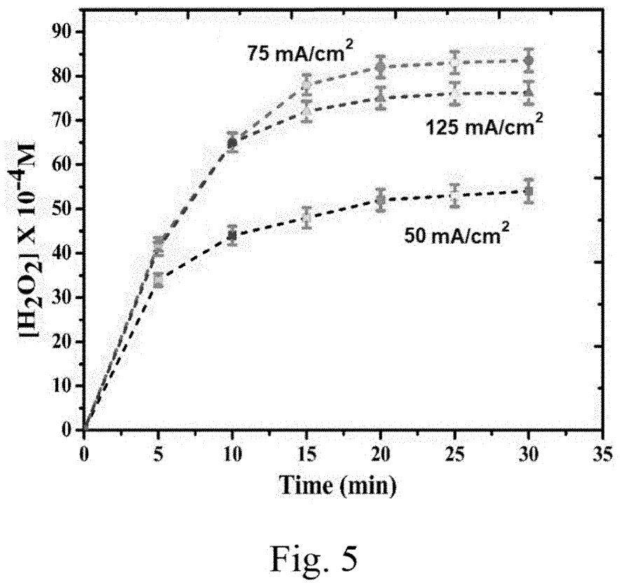

HYDROGEN PEROXIDE ELECTRO-GENERATION: The DFEF system was investigated for hydrogen peroxide electro-generation at different current densities as shown in FIG. 5, which is discussed in more detail below. The concentration of H₂O₂ increases with increases in both electrolysis time and current density up to 75 mA/cm². The trend evident in FIG. 5 may be ascribable to increased and faster generation hydroxyl radicals. That is, (i) .OH is generated via the Fenton reaction set forth above in Eq. 3, owing to enhanced production of H₂O₂ at the graphite felt electrode cathode resulting from RHS/C-xFe composite catalyst and the fabricated reactor design. Also, (ii) B (.OH)_{ads} is generated at the anode due to an increased reaction rate according to Eq. 9. A current density of 125 mA/cm² reduces the hydrogen peroxide electrogeneration likely due to H₂O₂ loss resulting from H₂O₂ oxidation at the anode to O₂ and H₂, governed by Equations 12 and 13.

H₂O₂→HO₂.+H⁺+e⁻ Eq. 12

HO₂.→O₂+H⁺+e⁻ Eq. 13

The progressive increase in H₂O₂ electrogeneration before electrolytic parameter optimization can be enhanced by adding heterogeneous catalyst and/or tailoring reactor design to allow a large surface area electrode to contact the sample solution.

EFFECT OF OPERATING CONDITIONS ON DEGRADATION: The 5-variable central composite design (CCD) design matrix, experimental and predicted responses resulting from percentage degradation of β-blockers are presented in Table 2. The experimental (%) degradation results of β-blockers ranges from 31.41 to 96.61, e.g., at least 25, 27.5, 30, 32.5, or 35% and/or up to 100, 99.9, 99, 98, 97, 96, or 95%, while the calculated values range between 33.2 and 96.02. To compare and correlate the independent variables and results, multiple regression analysis was conducted, as shown in Table 3, simplifying to a second order polynomial response full equation embodied in Equation 11, above.

TABLE 3
CCD regression table for DFEF degradation of β-blocker.

| Term | Coef | SE coef^{a} | T | P |
|---|---|---|---|---|
| Constant | 80.6611 | 1.4886 | 54.184 | <0.0001 |
| [β]₀, X₁ | −2.535 | 0.7618 | −3.327 | 0.007 |
| Cat, X₂ | 4.3683 | 0.7618 | 5.734 | <0.0001 |
| CD, X₃ | 5.3317 | 0.7618 | 6.998 | <0.0001 |
| E.T, X₄ | 15.3917 | 0.7618 | 20.203 | <0.0001 |
| pH, X₅ | 0.9558 | 0.7618 | 1.255 | 0.236 |
| [β]₀ × [β]₀ | 2.5714 | 0.6891 | 3.731 | 0.003 |
| Cat × Cat | −8.0599 | 0.6891 | −11.696 | <0.0001 |
| CD × CD | −0.2974 | 0.6891 | −0.432 | 0.674 |
| ET × ET | −4.1686 | 0.6891 | −6.049 | <0.0001 |
| pH × pH | −0.4324 | 0.6891 | −0.627 | 0.543 |
| [β]₀ × Cat | 1.2262 | 0.9331 | 1.314 | 0.216 |
| [β]₀ × CD | 0.1937 | 0.9331 | 0.208 | 0.839 |
| [β]₀ × ET | −1.75 | 0.9331 | −1.876 | 0.087 |
| [β]₀ × pH | 1.07 | 0.9331 | 1.147 | 0.276 |
| Cat × C.D | −0.9675 | 0.9331 | −1.037 | 0.322 |
| Cat × ET | −2.9237 | 0.9331 | −3.134 | 0.01 |
| Cat × pH | −0.4538 | 0.9331 | −0.486 | 0.636 |
| CD × ET | −1.1062 | 0.9331 | −1.186 | 0.261 |
| CD × pH | 2.7363 | 0.9331 | 2.933 | 0.014 |
| ET × pH | −2.74 | 0.9331 | −2.937 | 0.014 |

^{a}standard error coefficient

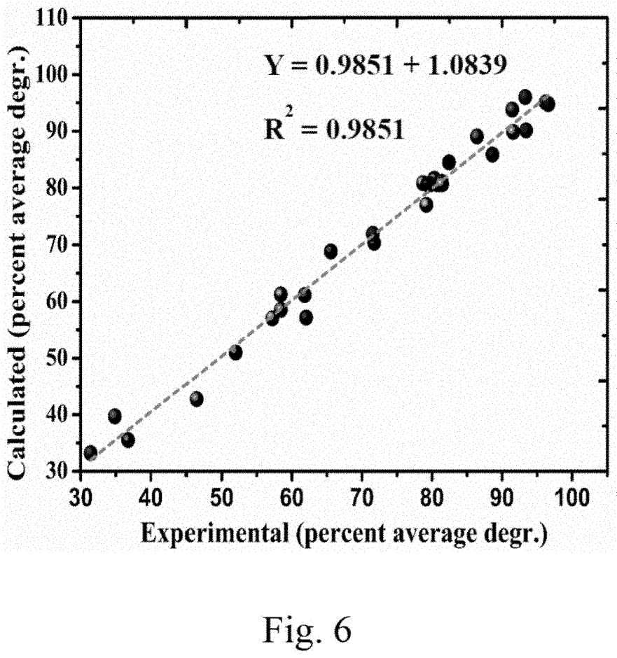

Central composite design (CCD) is capable of providing high-quality predictions over the entire design space using minimal experimental runs compared to other design types. A polynomial model is a reasonable representation that compares the experimental response and model predictions using normal probability plots. To assess and prove the reliability of the model, the predicted/calculated values were plotted against the experimental/actual degradation values (%) as shown in FIG. 6, resulting in data points that lie closer to a straight line with coefficient of determination (R²) values for average s-blocker, e.g., acebutolol (ACE) or propranolol (PROP). R² was experimentally determined to be 0.9851. R² values close to unity fall within the desirability limit, indicating that the model is capable of capturing the relationship between the input parameters and the output responses.

Analysis of Variance (ANOVA) further tests the adequacy and significance and adequacy of the CCD model by comparing the treatment and random errors variations underlying the measurements of the generated responses. Tables 3 and 4 show results of the quadratic responses represented as ANOVA residuals and regression coefficients.

TABLE 4
ANOVA for the degradation of β-blockers by DFEF.

| | | % degradation efficiency | | | |
|---|---|---|---|---|---|
| Source of variation | DOF | Adj. SS | Adj. MS | F value | P value |
| Regression model | 20 | 10,148.00 | 507.40 | 36.43 | <0.0001 |
| Linear | 5 | 7002.10 | 1400.41 | 100.54 | <0.0001 |
| Square | 5 | 2639.50 | 527.89 | 37.90 | <0.0001 |
| Interaction | 10 | 506.50 | 50.65 | 3.64 | 0.0220 |
| Residual error | 11 | 153.20 | 13.93 | | |
| Lack of fit | 6 | 149.10 | 24.86 | 30.45 | 0.0010 |
| Pure error | 5 | 4.10 | 0.82 | | |
| Total | 31 | 10,301.30 | | | |
| R-squared (R²) | | | | 98.51% | |
| Adjusted R² | | | | 95.81% | |
| (Adj R²) | | | | | |
| Predicted R² | | | | 88.03% | |
| (Pred R²) | | | | | |
| Standard deviation | | | | 0.829 | |
| (SD) | | | | | |

The F-value is obtained by dividing the mean squares (MS) of the model by that of the residual error. The smaller the difference between the F value and the tabulated value, here 2.352 at a significance of 95%, correlates to greater confidence in the ability of a given model/factor to explain adequately the existing variation. The F-value obtained, i.e., 36.43, was greater than the tabulated F-value and had P-value less than 0.0001, which statistically confirms the adequacy and significance of the CCD model.

In addition, the “P>F” values (P-values) of less than 0.05 at 95% confidence level indicate the significance of the model terms, while P-value greater than 0.05 are insignificant. The coefficient of determination (R²) of the regression equation is a measure of the overall variation in the data generated by the model. Hence, a good fit model based on acceptable data should have R² values closer to 1. The results for average β-blocker degradation is well fitted to the mathematical model with a regression coefficient (R²) of 0.9851, i.e., greater than 0.900. The high R² values determined further support the model's high capacity to predict responses. The model's “lack of fit” value was greater than 0.05, implying it is insignificant and indicating model's good predictability. Higher adjusted R² (95.81%) values closer to R² (98.51%) signify a desirable fitting quality between the model and the experimental data.

From ANOVA analysis in Table 3, the linear, square term effects, and the combined effects of Cat×ET, CD×pH, and ET×pH, were found to be significant, in that their P-values were less than 0.05 at significance level of 95%. This means that the selected factors for the CCD model can contribute towards β-blocker degradation (%). The interaction effects were generally identified based on p-values found to be less than 5% of significance level to confirm their statistical significance.

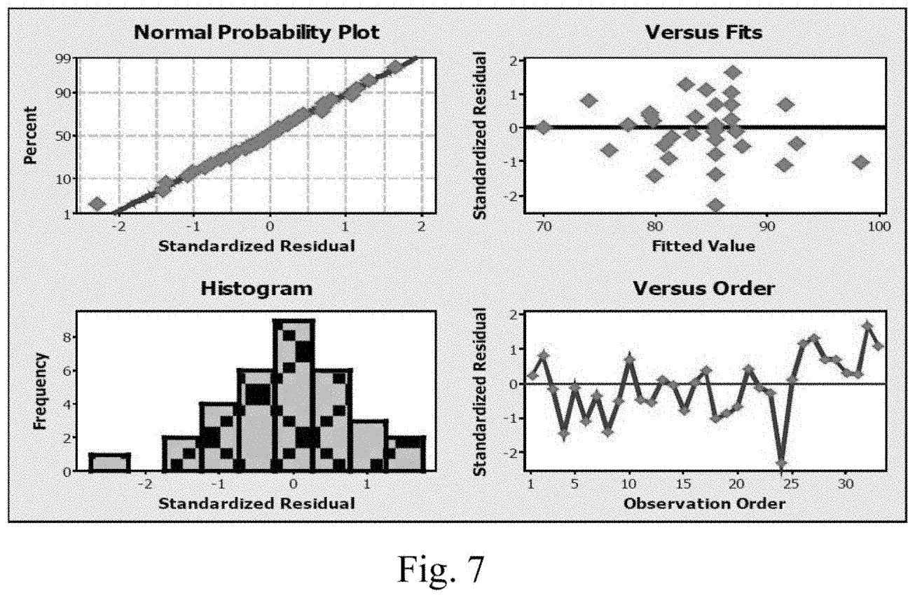

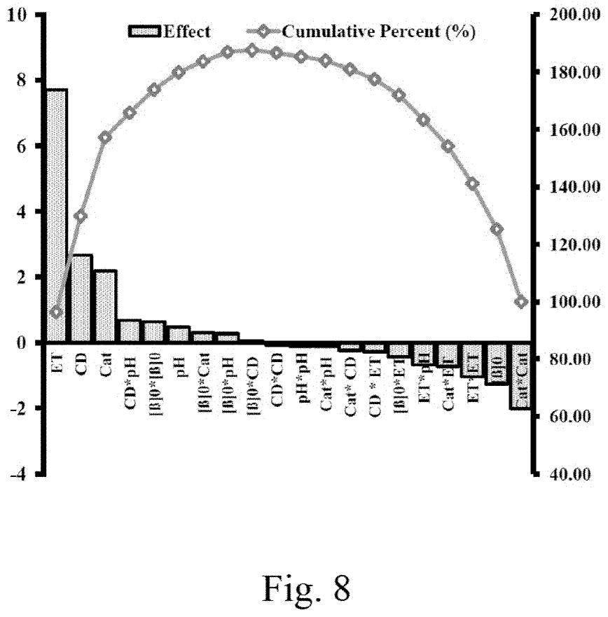

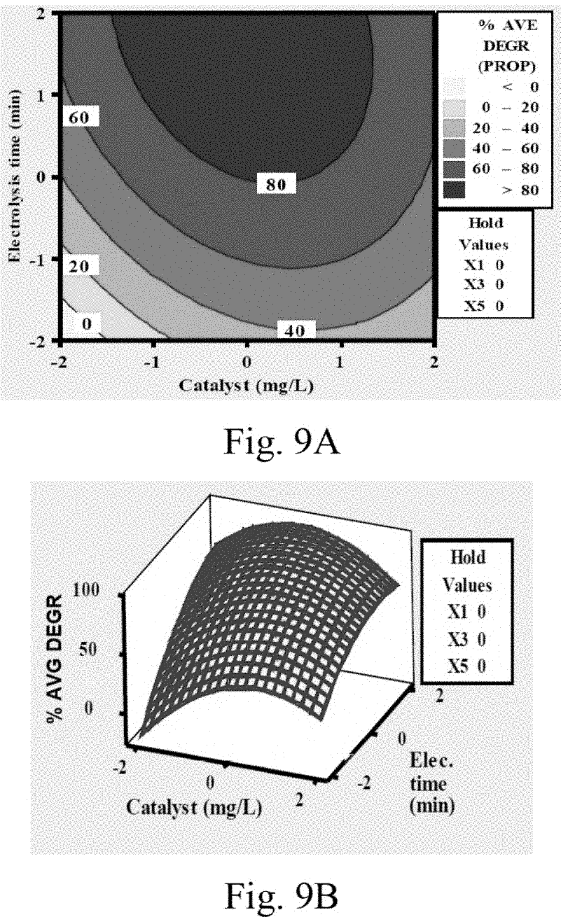

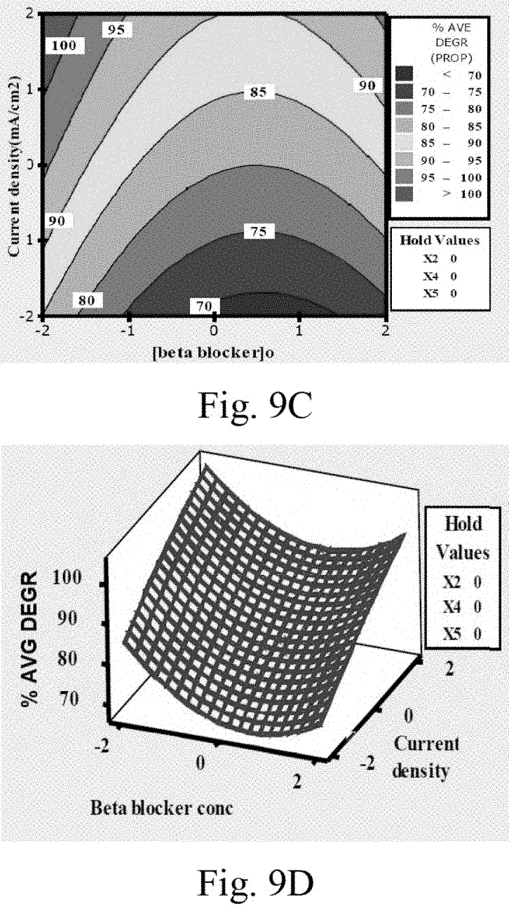

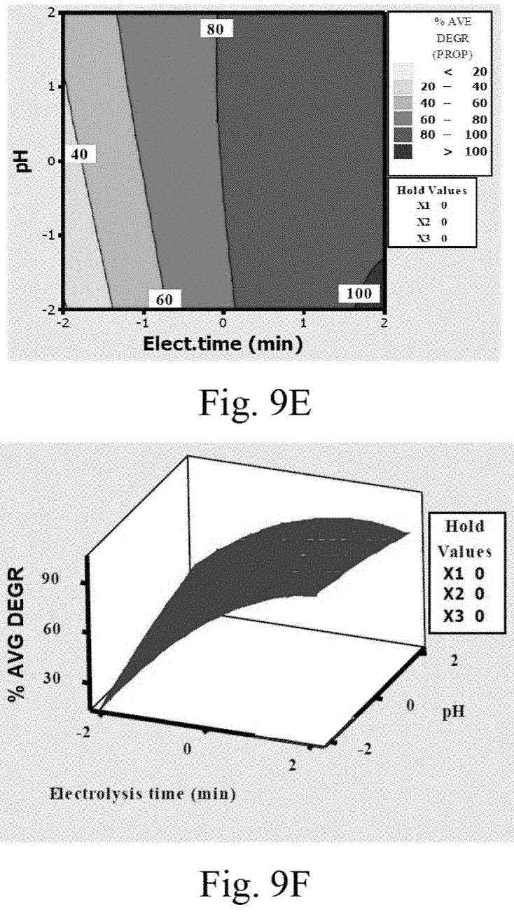

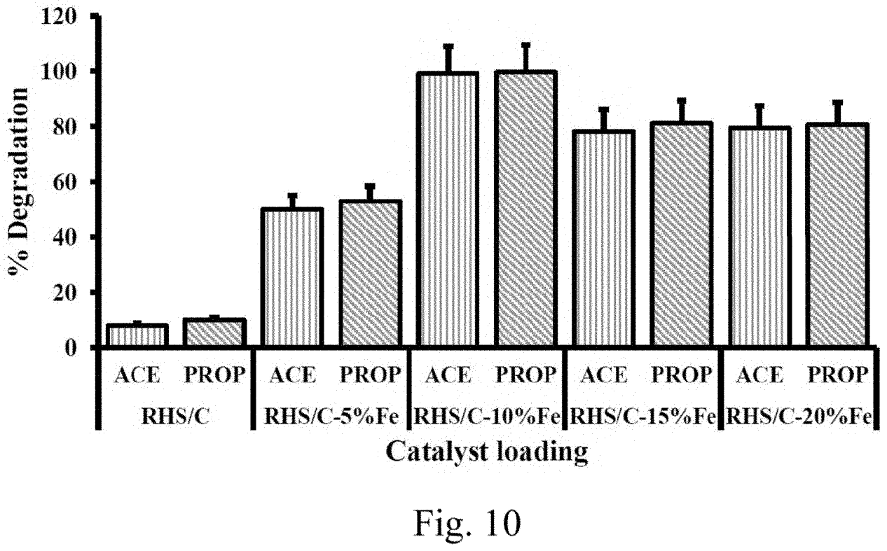

FIG. 7 shows further examination towards the validation of the central composite design (CCD) model using residual analysis. FIG. 8 shows a Pareto analysis chart to evaluate the effect and significance of each independent variable/combined effect on the degradation efficiency (%). FIG. 9A to 9F show two-dimensional contour and three-dimensional response surface plots were used to study the effect of the interactions between the independent variables on response (% degradation efficiency). FIG. 10 investigates the effect of iron concentration on the Fenton reaction/degradation efficiency.

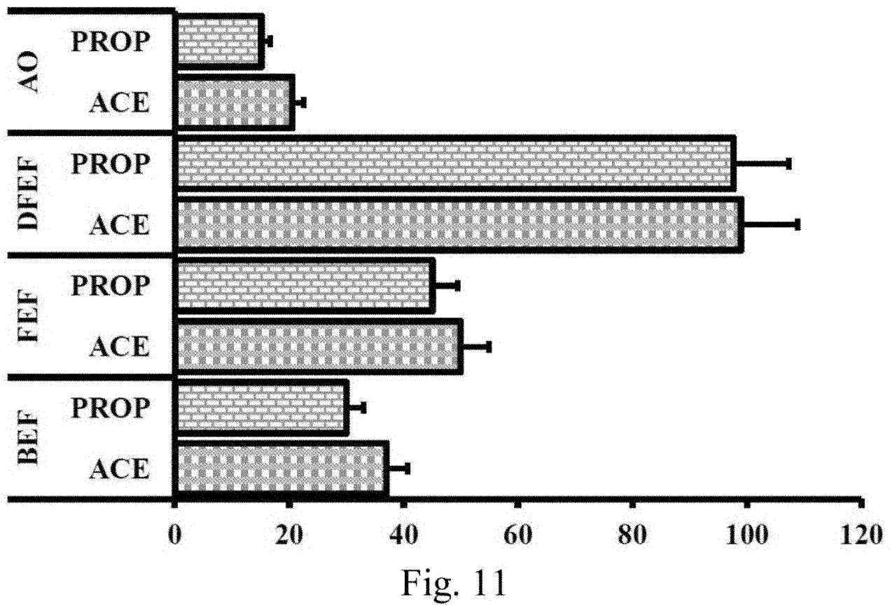

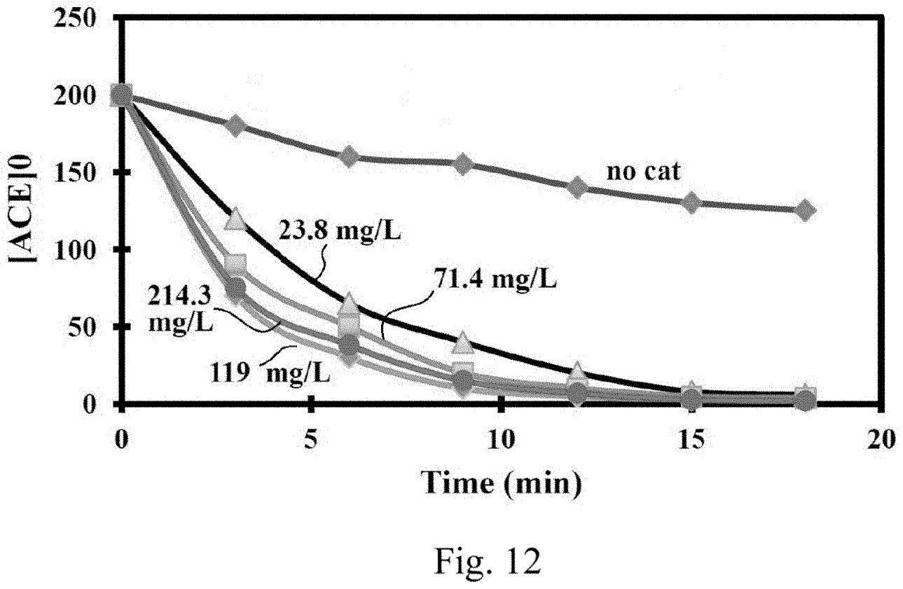

FIG. 11 shows charts comparing the degradation efficiency (% DE) of various Fenton techniques for certain beta-blockers, showing a comparison between droplet impingement flow-assisted electro-Fenton (DFEF) and other treatment modes. FIG. 12 shows the degradation or decay kinetics of β-blockers using the optimized droplet impingement flow-assisted electro-Fenton (DFEF) conditions with representative decay plots of acebutolol (ACE) under different amounts of RHS/C-10% Fe catalyst.

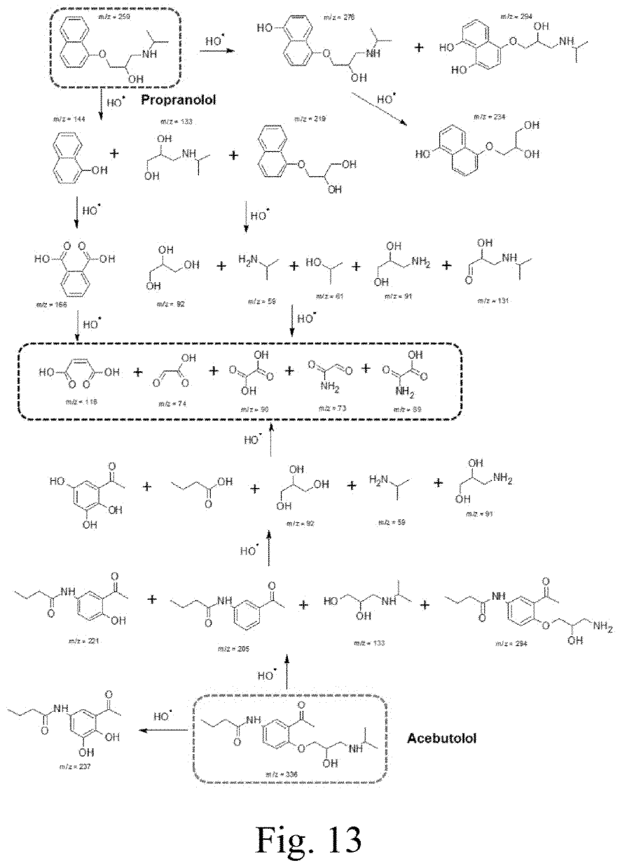

FIG. 13 show structures and reaction schemes related to the identification of degradation by-products of the Fenton reaction for particular β-blockers. The proposed degradation pathway for propranolol (PROP) is shown in the upper half of FIG. 13, and the proposed degradation pathway for acebutolol (ACE) is shown in the lower half.

Referring now to the drawings, wherein like reference numerals designate identical or corresponding parts throughout the several views.

FIG. 1 shows a schematic diagram of an exemplary droplet-impingement, flow-assisted electro-Fenton reactor useful to conduct inventive reactions. Silica/boron-doped diamond (Si/BDD) may be used as anode while the cathode may be graphite felt electrode (GFE), both with surface area of 4 cm², e.g., at least 1, 2, 3, 4, 5, 7.5, or 10 cm² and/or up to 20, 17.5, 15, 12.5, 10, or 8 cm², and connected to a direct current power supply (Sargent Welch Scientific AC/DC Power Supply, 0 to 22V, 4A) and a digital multimeter (auto Range AC/DC voltage/current, Fluke) that can supply and/or measure the current. Both electrodes may be placed at a distance of 1 cm, e.g., at least 1, 2, 3, 4, 5, 7.5, 9, 11, 12.5, or 15 mm, and/or up to 25, 22.5, 20, 17.5, 15, 12.5, or 10 mm, from the bottom of the reactor and the inter electrode gap maintained at 3 cm, e.g., at least 0.5, 1, 1.5, 2, 2.5, 3, 3.5, 4, 4.5, or 5 cm and/or up to 7.5, 6.5, 6, 5.5, 5, 4.5, 4, 3.5, or 3 cm. Prior to every experiment, electrodes surfaces can be cleaned and preconditioned with acetone (or methanol, ethanol, or the like) and 35% HCl (or comparable mineral acids) for 5 minutes and then rinsed with double distilled water. An air pump connected to the sample flow system, shown as a junction (9) in FIG. 1, may be used to generate a droplet spray of solution at the cathode surface and saturate the entire sample solution with dissolved oxygen needed for oxygen reduction reactions to generate hydrogen peroxide, shown as Equation 1 in Table 1. For all the experiments, the sample solution was stirred magnetically. Electrolytic degradation experiments were performed using initial f-blockers concentrations (200 to 1000 ng/mL) in 0.050 M Na₂SO₄ with defined amounts Fe—RHS/C-x % Fe as heterogeneous composite catalysts ranging between 23.8 to 214.3 mg/L, at sample pH (3 to un-adjusted pH), room temperature, and at a constant current densities ranging between 25 to 125 mA/cm². Beta-blocker concentrations may be, for example, at least 50, 100, 150, 200, 250, 300, 350 ng/mL and/or up to 10000, 7500, 5000, 4000, 3000, 2000, or 1000 ng/mL. The iron/rice husk silica/carbon (Fe—RHS/C-x % Fe) heterogeneous composite catalysts may be used in concentrations in a range of from 23.8 to 214.3 mg/mL, e.g., at least 15, 20, 25, 35, 50, or 100 mg/mL and/or up to 750, 500, 400, 300, 250, 225, 215, or 200 mg/mL. Current densities may range from 25 to 125 mA/cm², e.g., at least 15, 17.5, 20, 22.5, or 25 mA/cm² and/or 250, 225, 200, 175, 150, or 125 mA/cm². The pH used may be at least 2, 3, 4, 5, 6, or 7 and/or up to 10, 9, 8, or 7.

FIG. 2A shows the N₂ adsorption-desorption isotherms of the synthesized nanocomposites, exhibiting classical type IV isotherms with H3-type hysteresis loops under the IUPAC classification, which are typical of mesoporous compounds. Well-defined pore structure is confirmed by the pore size distributions of the nanocomposites shown in FIG. 2B. The pore distribution curves indicate a pore volume decrease with increasing iron loading, while the pore diameter increases in a similar trend. FIG. 2A indicates a shift in the hysteresis loops to higher P/P₀ of N₂ adsorption-desorption isotherms as a result of increased iron loading on RHS matrix. The major pore range for all the nanocomposites tested falls within the mesoporous range. The BET surface areas of these nanocomposite catalysts were 98.66 m²/g for RHS-0% Fe and 61.32 m²/g for RHS-10% Fe, e.g., at least 45, 50, 52.5, 55, 57.5, 60, 62.5, or 65 m²/g and/or up to 85, 80, 75, 70, 65, 62.5, or 60 m²/g. Further increases in iron loading decreased the specific surface area, likely due to inter-particle condensation of free hydroxyl group at higher calcination temperatures (e.g., 700° C.) that leads to the rearrangement of silica spheres leading to faster collapse of pore structure.

FIG. 3A shows a field emission scanning electron microscope (FE-SEM) image of RHS-10% Fe, while FIG. 3B shows an energy-dispersive X-ray spectroscopy (EDX) spectrum of RHS-10% Fe. FIG. 3C shows an FE-SEM image of RHS-10% Fe, while FIG. 3C shows an EDX spectrum of RHS-10% Fe. The FE-SEM images show that the catalysts prepared as described herein have well-resolved semi-spherical shapes characteristic of porous substance. A comparison of FIGS. 3A and 3C reveals that RHS-0% Fe is more porous than RHS-10% Fe, corroborating BET results in which specific surface area of RHS-0% Fe is relatively higher than that of RHS-10% Fe. The FE-SEM-EDX spectra indicate the successful loading of iron (Fe).

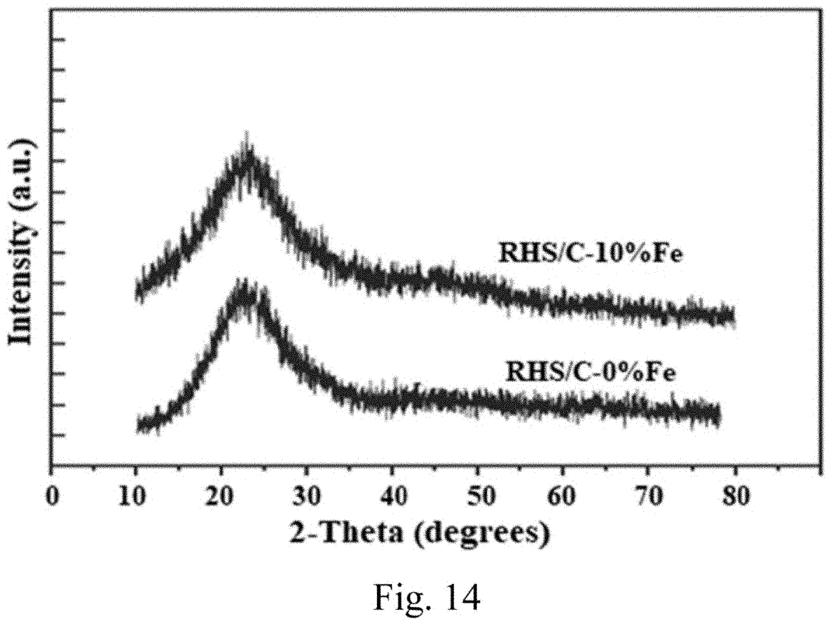

FIG. 3E shows a transmission electron microscopy (TEM) image of RHS-10% Fe, while FIG. 3F shows a TEM image of RHS-10% Fe, each with inset selected area electron diffraction (SAED) images. The TEM characterizations indicate that the effect of iron loading on the microstructure of the synthesized RHS-10% Fe nanocomposite catalyst, demonstrating in both samples uniform and highly disordered microstructures with no evidence of agglomeration. SAED insets in FIGS. 3C and 3D confirm the absence of crystalline material in both samples and confirmed their amorphous structures. These results corresponded with x-ray diffraction (XRD) patterns seen in FIG. 14, in which a broad peak typical of amorphous structures was observed at around 23 2Θ for both samples, confirming the absence of crystalline metal/metal oxide phases in the inventive nanocomposites even after metal loading.

FIGS. 4A, C, D, E, and F show x-ray photoelectron spectroscopy (XPS), a surface characterization technique used to ascertain composition and the oxidation state of elements within the sample, for the inventive nanocomposites, while FIG. 4B shows a chart of atomic composition. FIG. 4B shows a survey XPS spectrum of the nanocomposites, while FIG. 4C to F provide high resolution scans for relevant core levels recorded for a metal free (RHS-0% Fe) and RHS-10% Fe nanocomposite catalyst prepared as described herein. FIG. 4B reveals the XPS elemental composition of the survey spectra as: C-1s, O-1s, Si-1s, and Fe-2p, in appropriate amounts, i.e., corresponding to theory, for the two nanocomposite catalysts. The XPS spectra further indicate the presence of iron and carbon in the synthesized nanocomposites.

FIG. 4F shows Fe-2p spectra of an exemplary RHS—O % Fe nanocomposite catalyst, which was deconvoluted into two major binding energy peaks located at 711.4 and 724.8 eV. These peaks were assigned to Fe 2p_{3/2} and Fe 2p_{1/2} orbitals of the lattice Fe³⁺ of Fe₂O₃. These Fe-2p peak details are in the ranges reported in the art. X₃ in FIG. 4F is a shake-up satellite peak characteristic of Fe₂O₃ lattice, also reported in the art. The XPS core-level effects of C-1s after curve fitting is displayed in FIG. 4E as a strong peak at 284 eV, corresponding to graphite carbon, and the shoulder peak at 286.3 eV corresponds to carbon linked to hydroxyl group. The deconvoluted spectra for silicon (Si-1s) and oxygen (O-1s) are presented in FIGS. 4C and 4D, which show a binding energy peak at 102.5 eV assigned to silicon, while peaks at 529.2 and 531.1 eV are assigned to O-1s and are typical of Fe₂O₃ and Si₂, respectively.

FIG. 5 shows plots correlating the amounts of electrogenerated H₂O₂ as a function of time at room temperature, using a droplet-impingement flow-assisted electro-Fenton reactor /reaction as described herein. In the plots in FIG. 5, the concentration of Na₂SO₄, [Na₂SO₄], is 0.05 M, the initial concentration of beta-blockers, [β-blockers]₀, is 200 ng/mL, and the concentration of RHS-10% Fe, [RHS-10% Fe], is 119 mg/L, as a heterogeneous catalyst source. In the plots in FIG. 5, no pH adjustment was conducted.

FIG. 6 shows calculated versus experimental percentage average degradation for β-blockers. There is good agreement between the experimental data and the theoretical percent average degradation, i.e., an R² value of 0.9851, which may be at least 0.95, 0.97.5, 0.98, 0.985, 0.99, or 0.995.

FIG. 7 shows further examination towards the validation of the central composite design (CCD) model using residual analysis. The normalcy of these residuals signified error consistence with acceptable normal distribution, generating a completely randomized design. The residuals in the upper left of FIG. 7 lie along a straight line, indicating that normality of residual distribution. These results therefore indicate a good correlation between the experimental values and the model.

FIG. 8 shows a Pareto analysis chart to evaluate the effect and significance of each independent variable/combined effect on the degradation efficiency (%) using Equation 15:

$${P}_{i} = ( \frac{{b}_{i}^{2}}{{\sum }_{i = 1}^{n} {b}_{i}^{2}} ) \times 100. \qquad Eq . 15$$

The terms/effects on negative side of the Pareto chart in FIG. 8 signify that the individual, square, or interactive parameter(s) are/is antagonistic towards response, while the positive effects signify synergistic effect towards response. The dominance of the individual, square, or interactive parameter(s) are/is determined by the height of the term/effect. Among the main parameters, electrolysis time (ET) is the most influential variable towards response, followed by current density (CD), then catalyst concentration (Cat). These main factors displayed a pronounced synergistic effect while the initial β-blocker concentration, [β]₀, effects were antagonistic towards β-blocker degradation efficiency. In addition, the compounded effect of CD×pH, [β]₀×[β]₀, [β]₀×Cat and [β]₀×pH were synergistic while Cat×ET, ET×pH, Cat×Cat, and ET×ET were found antagonistic.

FIG. 9A to 9F show two-dimensional contour and three-dimensional response surface plots were used to study the effect of the interactions between the independent variables on response (% degradation efficiency). FIGS. 9A and 9B demonstrate the simultaneous effect of catalyst concentration (Cat) and electrolysis time (ET) on β-blocker degradation efficiency (%). Both catalyst concentration and electrolysis time individually can exhibit synergistic effects. However, the interaction between catalyst concentration and electrolysis time can be antagonistic towards degradation. Simultaneous increase of both Cat (RHS/C-10% composite) and ET can decrease the degradation efficiency. These results are supported by the Pareto chart analysis in FIG. 8 and the regression analysis in Table 4. Initially, there was found to be an increased production of .OH, apparently from the increasing leaching of Fe³⁺ ions, as seen in Equations 2 and 3, above, for RHS/C-10% Fe composite catalyst. However, beyond the optimum value, the degradation efficiency appears to reduce due to scavenging effects of Fe²⁺, according to Equations 6 and 7.

FIGS. 9C and 9D demonstrate the interaction of initial β-blocker concentration, [β-blocker]₀, with current density on degradation efficiency. An initial increase in both β-blocker concentration and current density can increase β-blocker degradation, possibly due to enhanced electrogeneration of hydrogen peroxide and subsequent hydroxyl radical production. These effects indicate a weak synergistic effect of the cross interaction term of initial β-blocker concentration and current density, [β-blockers]₀×CD, in the regression analysis and Pareto analysis.

FIGS. 9E and 9F shows the effect of electrolysis time and sample pH as a function of % degradation at a fixed β-blocker concentration, [β-blocker]₀, of 200 ng/mL, catalyst concentration, Cat, of 119 mg/L, and current density, CD, of 75 mA/cm². Electrolysis time, ET, sample pH, and the compounded effect of the two factors, i.e., ET×pH, all were determined to exhibit synergistic effect towards degradation. However, under similar operational parameters, identical .OH radicals may be produced that react with both β-blocker molecules and their degradation intermediates.

Response optimization based on desirability function was used in identification of optimum conditions of the variables resulting in a maximum response. A target value for the % β-blocker degradation was set at 100%, a lower value of 31.41, an upper value of 110 (since the upper value has to be greater than the target value), and finally the importance and weight were both set to 1. The optimized conditions for degradation of β-blockers with a composite desirability score of 0.99981 were found to be a catalyst concentration of 119 mg/L, current density of 75 mA/cm², electrolysis time of 15 minutes, sample pH of 3, and [β-blocker]₀ of 200 ng/mL, to realize 99.99% degradation efficiency. Triplicate experiments were conducted at optimized degradation conditions resulting in complete degradation efficiency for both propranolol (PROP) and acebutolol (ACE).

FIG. 10 shows charts of degradation percentage for exemplary catalysts of varying Fe content using the selection characteristics: 200 μg/L β-blocker sample solution at room temperature, current density of 5 mA/cm², pH of 3, concentration of Na₂SO₄, [Na₂SO₄]₀, or 0.05 mol/L; concentration of RHS-x % Fe catalyst of 119 mg/L; and 15 minutes of electrolysis time. As seen in FIG. 10, the effect of iron concentration on the Fenton reaction /degradation efficiency can guide the selection of a suitable iron-loading in RHS/C-x % Fe composite catalyst. The oxidation power of the electro-Fenton process may be enhanced by the efficient Fe²⁺ regeneration. Thus, the selection of a suitable heterogeneous catalyst by varying iron content, i.e., RHS/C-0 to 20% Fe, for effective electro-Fenton degradation was investigated. FIG. 10 shows that a rise in the initial iron loading to the RHS/C-x % Fe composite from 0 to 10% can enhance the % degradation of β-blocker. However, beyond 10% Fe loading, the degradation efficiency may undergo a decrease, which may be significant. This trend may be explained by scavenging of electrogenerated .OH with excess Fe²⁺ via the reaction governed by Equations 6 and 7, above. The system's capacity to generate hydroxyl radical may reduce gradually, decreasing β-blocker degradation efficiency. Hence a RHS-10% Fe nanocomposite was selected for subsequent experiments.

Because of the relatively low BET surface area of RHS/C-10% composite catalyst, it was assumed that the contribution of catalyst adsorption of β-blockers in contaminated water, such as hospital waste water, is negligible. Dispersion of the iron and carbon nanoparticles effectively increases the number of active sites on the nanocomposite catalyst, leading to effective H₂O₂ catalytic activity improvement.

FIG. 11 shows charts comparing the degradation efficiency (% DE) of various Fenton techniques for certain beta-blockers, showing a comparison between droplet impingement flow-assisted electro-Fenton (DFEF) and other treatment modes. The reaction employed a 200 μg/L β-blocker sample solution at room temperature with a current density of 75 mA/cm², at a pH of 3, a [Na₂SO₄]₀ of 0.05 mol/L, RHS-15% Fe concentration of 119 mg/L. The abbreviation “AO” means anodic oxidation, “BEF” means batch electro-Fenton process, “FEF” means flow assisted electro-Fenton process, and “DFEF” means droplet impingement flow-assisted electro-Fenton process.

Similar experimental set-ups were used at optimized conditions with some modifications to correct for the mode used. With AO, the experiments were run in absence of RHS/C-10% Fe catalyst. Results obtained from the study indicate a performance trend of: AO<BEF<FEF<DFEF. Improved β-blockers degradation efficiency (%) by DFEF as seen in FIG. 11 may be due to combined enhancement effects leading to accelerated electrogeneration of hydroxyl radicals. The DFEF method appears to be favored by the synergistic degradation contributed by droplet chemistry in flow mode, and micro-electrolysis from the iron-carbon nanocomposite. For anodic oxidations, highly reactive .OH radicals are generated from the water oxidation, represented by Equation 9, above, and the .OH radicals get adsorbed at the BDD electrode, i.e., the anode. The electro-Fenton reaction, represented by Equations 1 to 3, leads to bulk generation .OH radicals in the sample solution, which contribute towards effective oxidation of β-blockers.

FIG. 12 shows the degradation or decay kinetics of β-blockers using the optimized droplet impingement flow-assisted electro-Fenton (DFEF) conditions with representative decay plots of acebutolol (ACE) under different amounts of RHS/C-10% Fe catalyst. The continuous electrogeneration of .OH in a heterogeneous electro-Fenton process may depend on the catalyst concentration. The electrochemical degradation/decay of a β-blocker sample solution at 200 ng/mL was performed with varied initial concentrations of iron-carbon composite, RHS-10% Fe, and at a current density of 119 mA/cm². The degradation of β-blockers presented in FIG. 12 may be attributed to a compounded effect of anodic oxidation, electro-Fenton, and micro-electrolysis in the presence of a heterogeneous Fe—C composite catalyst, RHS-10% Fe, for acebutolol (ACE). An insignificant degradation of β-blockers is realized in the absence of catalyst.

The fastest degradation of acebutolol (ACE) at 10 minutes, and almost complete degradation takes place within 15 minutes, of DFEF treatment was realized with 119 mg/L. Based on these results, the degradation of β-blockers in the DFEF system appears to depend substantially on the electrogeneration of bulk .OH radicals in the entire sample solution via a Fenton reaction and the adsorbed hydroxyl radicals (.OHₖ) at BDD anode. These .OH radicals are capable of degrading β-blockers and even other micro-pollutants present in the sample solution to total mineralization according to Equations 16 and 17.

β-blocker+.OH_{bulk}+.OH_{ads}→byproducts Eq. 16

byproducts+.OH_{bulk}+.OH_{ads}→CO₂+H₂O Eq. 17

The exponential decrease of concentrations of β-blockers, acebutolol (ACE) and propranolol (PROP), with time indicates that the degradation by .OH radicals follows pseudo-first order reaction kinetics assuming quasi-static concentration of .OH radicals. This trend in behavior is similar to reports in the art regarding oxidative degradation of organic pollutants with strongly oxidizing hydroxyl radicals. Equations 18 to 21, below, were utilized in determining the pseudo first-order rate constants (k_{obs}), wherein c is the concentration of β-blocker at t time and C₀ is the 200 ng/mL of the initial concentration: two kinds of radicals react with β-blocker at different reaction rates denoted as kₐ and k_{b} respectively.

$$\begin{matrix}\begin{matrix}\frac{- d [ ß - blocker ]}{dt} = ( {k}_{a} [ {•OH}_{bulk} ] + {k}_{a} [ {•OH}_{ads} ] ) [ ß - blocker ] & Eq . 18 \\ = {k}_{observed} [ ß - blocker ] & Eq . 19\end{matrix} \\ Eq . 20 \\ - \frac{dC}{dt} = {k}_{observed} C , hence , ln C = - {k}_{observed} t + ln {C}_{0} \\ ( t = 0 , C = {C}_{0} ) \\ Therefore , \\ Eq . 21 \\ ln ( \frac{{C}_{0}}{C} ) = {k}_{observed} t\end{matrix}$$

Plotting ln (c₀/c) against t resulting from the degradation of varied amounts of β-blockers solution with various initial RHS/C-10% Fe composite catalyst amounts generated results presented in Table 5. The observed rate constant values (k_{obs}), which were pseudo first-order, were calculated from linear regression analysis and the k_{obs} values with their corresponding regression coefficients (linear R²) are tabulated in Table 5.

TABLE 5
Pseudo first-order rate constants and regression coefficients
for degradation of β-blockers. (Change the catalyst in % wt)

| [β- | | | | | |
|---|---|---|---|---|---|
| blocker]₀ | RHS-10% Fe | K_{obs} ACE | K_{obs} PROP | R² | R² |
| (ng/L) | (mg/L) | (/min) × 100 | (/min) × 100 | ACE | PROP |
| 200 | 0 | 0.19 | 0.16 | 0.9856 | 0.9776 |
| 200 | 23.8 | 2.06 | 1.9 | 0.9932 | 0.9952 |
| 200 | 71.4 | 2.23 | 2.05 | 0.9924 | 0.9944 |
| 200 | 119 | 2.72 | 2.54 | 0.9954 | 0.9964 |
| 200 | 166.7 | 2.34 | 2.16 | 0.9947 | 0.9987 |
| 100 | 119 | 3.62 | 3.57 | 0.9973 | 0.9953 |
| 400 | 119 | 1.53 | 1.39 | 0.9933 | 0.9953 |

Regression coefficient (R²) values higher than 0.98 for both acebutolol (ACE) and propranolol (PROP) indicate that the degradation process fits well to a pseudo first-order reaction. There is an increase in the observed rate constant, k_{obs}, for both β-blockers, i.e., acebutolol (ACE) and propranolol (PROP), in the ranges of 0.19 to 2.72×10⁻²/min for acebutolol (ACE) and 0.16 to 2.54×10⁻²/min for propranolol (PROP), on increasing amounts of RHS-10% Fe catalyst from 0.119 mg/L. The observed trend indicates that the degradation of β-blockers is mainly by .OH attributed by E-Fenton process, rather than .OH_{adsorbed} for anodic oxidation. However, increasing the amount of catalyst beyond 119 mg/L, i.e., to 166.7 mg/L, decreases the K_{observed} to 2.34×10⁻²/min for acebutolol (ACE) and 2.16×10⁻²/min for propranolol (PROP), considered mainly due to quenching of .OH by excess Fe²⁺ present as a result of RHS-10% Fe composite catalyst addition and micro-electrolysis, as indicated in Equation 7, above. Fast reaction rates (K_{observed}) of 3.62×10⁻²/min and 3.57×10⁻²/min for acebutolol (ACE) and propranolol (PROP) were realized when the initial β-blocker concentration of 100 ng/mL was halved. However, on doubling the initial concentration to 400 ng/mL, the K_{b},d decreased to 1.53×10⁻²/min for acebutolol (ACE) and 1.39×10⁻²/min for propranolol (PROP). Different byproducts are formed by the reaction between .OH radicals and the β-blockers, when the concentration is increased, the available .OH radicals compete with the increased formation of β-blocker degradation byproducts leading to a decrease in reaction rate.

FIG. 13 show structures and degradation pathways related to the identification of degradation by-products of the Fenton reaction the β-blockers, acebutolol (ACE) and propranolol (PROP), relying on data obtained from LC-MS/MS line spectra studies of each degradation product. To avoid fast degradation of β-blocker intermediates, a low current density of 50 mA/cm² for 10 minutes at a β-blocker concentration of 1000 ng/mL were used. Under these weak oxidation conditions, the most stable carboxylic acids and aromatics are yielded. The electrochemical degradation pathway of β-blockers appears to follow two main routes: (1) side chain cleavage resulting to amino-diol; and (2) hydroxylation of the aromatic ring, followed by formation of keto-derivatives after the ring opening. Both acebutolol (ACE) and propranolol (PROP) contain two main active sites during the reaction with .OH, aromatic groups and aliphatic chains with amine, amide and ether groups. The primary step during the reaction of .OH with acebutolol (ACE) and propranolol (PROP) include oxidative C—H insertion of .OH followed by the cleavage of C—O bond resulting in 1-naphthol and an aliphatic group. Competing reactions with the previous one are the oxidative cleavage of C—N bond as well as the oxidative hydroxylation of aromatic group that results in poly hydroxylated naphthol derivatives. Further oxidation of the resultant byproducts by .OH appear to generate relatively stable, highly oxidized small molecular weight carboxylic acid derivatives, such as malic, oxalic, and oxamic acids. The proposed degradation mechanism of propranolol (PROP) is shown in the upper half of FIG. 13.

A similar reaction sequence for acebutolol (ACE) was observed during the .OH treatment. First, oxidative cleavage of a C—O bond takes place to generate a phenol derivative and an alkyl group, followed by the cleavage of C—N bond, as seen in the lower half of FIG. 13. Oxidative hydroxylation of the phenyl group also appears to take place despite the electron withdrawing acetyl group, albeit to a lesser extent than for the naphthol group of the propranolol (PROP).

FIG. 14 shows x-ray diffraction (XRD) spectra for exemplary RHS-0% Fe and RHS-10% Fe nanocomposites as described herein, conducted on nanocomposites synthesized as described herein at a continuous scan rate of 0.5°/min, 0.02° scan size and the Bragg's angle (20) range of 10 to 80°. In the XRD, a broad peak typical of amorphous structures can be observed at around 23 2Θ for both samples, confirming the absence of crystalline metal/metal oxide phases in the inventive nanocomposites even after metal loading.

Numerous modifications and variations of the present invention are possible in light of the above teachings. It is therefore to be understood that within the scope of the appended claims, the invention may be practiced otherwise than as specifically described herein.

### REFERENCE SIGNS

1 graphite felt electrode acting as cathode
2 boron-doped diamond (BDD) electrode acting as anode
3 DC power supply
4 air pump
5 magnetic stirrer
6 dual-headed peristaltic pump
7 sample holder
8 outlet flow
9 junction for mixing air with untreated sample to form a droplet-flow impingement E-Fenton system

1: An electrochemical cell, comprising:
a carbon-based cathode;
an anode;
a heterogeneous catalyst;
an electrolyte solution in contact with the cathode, the anode, and the catalyst; and
a source of gaseous oxygen configured to produce oxygen-containing bubbles in the electrolyte solution near the carbon-based cathode,
wherein the catalyst comprises:
Fe³⁺ ions in a range of from 5 to 20 wt. %, based on total catalyst weight; and
a support comprising at least 75 wt. %, based on total support weight, of a mesoporous amorphous silica, the support being impregnated with the Fe³⁺ ions.

2: The cell of claim 1, wherein the catalyst has a BET surface area in a range of from 25 to 100 m²/g.

3: The cell of claim 1, wherein the catalyst has an average pore diameter in a range of from 2 to 20 nm.

4: The cell of claim 1, wherein the catalyst is present in the electrolyte solution in a range of from 50 to 200 μg/mL electrolyte solution.

5: The cell of claim 1, wherein the mesoporous amorphous silica of the support is made by a process comprising:
contacting a silicate with a structure directing agent comprising glycerol, to obtain a mixture comprising the silicate and the glycerol; and
calcining the mixture for at least 1 hour at a temperature in a range of from 500 to 1000° C.

6: The cell of claim 1, wherein the structure directing agent further comprises a fatty acid ammonium halide.

7: The cell of claim 1, wherein the anode is a silicon/boron-doped diamond anode.

8: The cell of claim 1, wherein the cathode is a polymer-based graphite felt electrode.

9: The cell of claim 1, wherein the catalyst is present in the electrolyte solution in a concentration in a range of from 25 to 500 gm/L.

10: A method, comprising:
passing water comprising an organic compound through the electrochemical cell of claim 1, thereby subjecting the organic compound to a droplet-impingement, flow-assisted Fenton reaction to degrade the organic compound,
wherein the passing reduces a content of the organic compound in the water by at least 90 wt. % from an inlet of the cell to an outlet of the cell within 20 minutes.

11: A method for degrading one or more organic compounds using the electrochemical cell of claim 1, the method comprising:
subjecting the cathode and the anode to a potential to produce current densities in a range of 50 to 150 mA/cm² while producing bubbles comprising O₂ in the electrolyte solution comprising an organic compound, thereby generating hydroxyl radicals in the electrolyte solution which react with the organic compound,
wherein at least 90 wt % of the organic compound, relative to a total initial weight of the organic compound, is degraded after subjecting for a time period of 10 to 20 min.

12: The method of claim 11, wherein the electrolyte solution comprises the organic compound at an initial concentration in a range of from 0.1 to 2.0 μg/mL electrolyte solution,

13: The method of claim 11, wherein the anode comprises boron-doped diamond in contact with the electrolyte solution.

14: The method of claim 11, wherein the electrolyte solution comprises two or more organic compounds which are degraded in the method.

15: The method of claim 11, comprising:
flowing a waste water through the electrochemical cell comprising the electrolyte solution.

16: The method of claim 11, wherein the bubbles comprising O₂ are air bubbles.

17: The method of claim 11, wherein the catalyst is present in the electrolyte solution in a concentration in a range of from 25 to 500 gm/L.

18: A heterogeneous catalyst, comprising:
Fe³⁺ ions in a range of from 8 to 12 wt. %, based on total catalyst weight; and
a support comprising at least 75 wt. %, based on total support weight, of a mesoporous amorphous silica, the support being impregnated with the Fe³⁺ ions,
wherein the catalyst has a BET surface area in a range of from 50 to 80 m²/g,
wherein the catalyst has an average pore diameter in a range of from 4 to 10 nm, and
wherein the mesoporous amorphous silica is produced by a process comprising calcining a mixture comprising a silicate and a structure directing agent comprising glycerol.

19: A method of making the catalyst of claim 18, the method comprising:
calcining rice husks to produce rice husk ash;
mixing the rice husk ash with an inorganic base to produce a silicate solution;
mixing the structure directing agent with the silicate solution to produce a gel;
contacting the gel with an inorganic acid and the Fe³⁺ ions to produce a loaded gel; and
washing and calcining the loaded gel to produce the composite catalyst.

20: The method of claim 19, wherein the structure directing agent further comprises a fatty acid ammonium halide.
